(19) United States
(12) Patent Application Publication
(10) Pub. No.: US 2023/0168561 A1
(43) Pub. Date: Jun. 1, 2023

(54) ELECTRO-OPTICAL MODULATORS AND APPLICATIONS BASED ON SILICON PROCESSING COMPATIBLE NONLINEAR OPTICAL MATERIALS

(71) Applicant: The Regents of the University of California, Oakland, CA (US)

(72) Inventors: Yeshaiahu Fainman, San Diego, CA (US); Alexei Smolyaninov, San Diego, CA (US); Dhaifallah Almutairi, San Diego, CA (US); Andrew Ingram, San Diego, CA (US); Andrew Grieco, La Jolla, CA (US); Naif Alshamrani, San Diego, CA (US); Alex Friedman, Escondido, CA (US); Hani Nejadriahi, La Jolla, CA (US); Rajat Sharma, La Jolla, CA (US); Dmitrii Belogolovskii, La Jolla, CA (US)

(21) Appl. No.: 18/049,281

(22) Filed: Oct. 24, 2022

Related U.S. Application Data
(60) Provisional application No. 63/270,948, filed on Oct. 22, 2021.

(51) Int. Cl. G02F 1/29; G02F 1/355; G02F 1/35; G01S 7/481

(52) U.S. Cl. CPC G02F 1/292; G02F 1/3556; G02F 1/3501; G01S 7/4817

(57) ABSTRACT

The technology disclosed in this patent document for optical devices for modulating light using nonlinear optical materials exhibiting electro-optical effects. Suitable nonlinear optical materials can be formed over a silicon-based semiconductor substrate via a silicon processing compatible process. In one application, such a device can be implemented for steering light based on a unique two-dimensional array of phased optical modulators using integrated photonic chip fabrication technologies to provide high performance and small footprint device packaging. The phased optical modulators can be phase shifting elements, each of which can be configured as a vertical-cavity surface-emitting phase shifter (VCSEP) to provide effective phase changes via both the control of the optical refractive index of the nonlinear optical material and the metal-dielectric surface plasmon effect.

### CROSS REFERENCE TO RELATED APPLICATION

This patent document claims priority to and benefits of U.S. Provisional Patent Application No. 63/270,948 entitled “Vertical-Cavity Surface-Emitting Phase Shifter” and filed on Oct. 22, 2021. The entire content of the aforementioned patent application is incorporated by reference as part of the disclosure of this application.

### TECHNICAL FIELD

This patent document is directed to devices and techniques for light modulation or manipulation based on silicon processing compatible nonlinear optical materials and electro-optical modulation and their uses in various applications including optical devices for steering light and their applications.

### BACKGROUND

Optical devices with nonlinear optical properties have a wide range of applications. Various nonlinear optical materials are available for constructing such optical devices. Some examples include lithium-niobate-on-insulator material structures, high-k ferroelectric perovskites such as barium titanate (BaTiO₃) and others. Some of those nonlinear optical materials exhibit low refractive indices relative to the index of silicon, and relatively high RF permittivity values which may be undesirable in various applications. Notably, the above and other nonlinear optical materials may not be suited for fabrication in silicon processing for CMOS circuits over silicon substrates. There is a need for developing CMOS-compatible nonlinear optical materials for silicon photonics circuits and other silicon-based circuits or integrated devices.

### SUMMARY

The technology disclosed in this patent document can be implemented to construct optical devices with a nonlinear optical material structure formed over a silicon-based semiconductor substrate to receive and guide light and structured to include a nonlinear optical material that is formed via silicon processing compatible process.

In one aspect, the disclosed technology can be used to construct a device for modulating light which includes a semiconductor substrate including silicon; and a nonlinear optical material structure formed over the semiconductor substrate to receive and guide light and structured to include a nonlinear optical material that is formed via silicon processing compatible process and includes a silicon-rich nitride (SRN) material. This device includes one or more electrodes formed near the nonlinear optical material structure to apply an electrical control signal to cause a nonlinear optical effect in the nonlinear optical material structure to modulate the light guided by the nonlinear optical material structure. In some implementations, this device includes a silicon oxide layer formed over the semiconductor substrate so that the nonlinear optical material structure is embedded in the silicon oxide layer, and the one or more electrodes are formed over the silicon oxide layer. In some implementations, the nonlinear optical material structure includes a portion that forms an optical waveguide, and a signal electrode is formed over the silicon oxide layer and located above the optical waveguide as one of the electrodes and two ground electrodes formed over the silicon oxide layer and located on two opposite sides of the optical waveguide as part of the electrodes so that the two ground electrodes are grounded and the signal electrode receives and applies the electrical control signal to modulate the light guided by the nonlinear optical material structure. In some other implementations, the device can be a semiconductor cylindrical core formed over the semiconductor substrate to protrude above the semiconductor substrate, the nonlinear optical material structure includes a hollow nonlinear optical material cylinder protruded above the substrate to be in contact with and to enclose sidewalls of the semiconductor cylindrical core, and an external metal layer is formed on an exterior cylindrical side surface of the hollow nonlinear optical material cylinder as part of the one or more electrodes to apply the electrical control signal to the hollow nonlinear optical material cylinder to modulate the light present at the nonlinear optical material structure to cause a phase shift of the light upon transmission through the semiconductor cylindrical core and the hollow nonlinear optical material cylinder.

The disclosed technology can be used in beam scanning or steering applications to minimize or eliminate mechanical components, moving parts, and bulk optics and to improve the device reliability and reduce device cost. The technology disclosed in this patent document can be implemented to construct optical devices for steering light based on a unique two-dimensional (2D) array of phased optical modulators fabricated by using integrated photonic chip fabrication technologies to provide high performance and small footprint device packaging. The phased optical modulators can be phase shifting elements, each of which can be configured as a vertical-cavity surface-emitting phase shifter (VCSEP) to provide effective phase changes via both the control of the optical refractive index of the nonlinear optical material and the metal-dielectric surface plasmon effect.

In some implementations, the technology disclosed in this patent document can be used to provide a device that includes an optical beam steering and scanning module which steers, controls or scans a direction of light. The optical beam steering and scanning module includes: a substrate; an array of phase shifting elements supported by the substrate and spaced from one another to receive light incident to one side of the substrate and to interact with the incident light to produce transmitted light on an opposite side of the substrate, each phase shifting element coupled to receive an electrical control signal applied to the phase shifting element and structured to be operable to cause a phase shift on the transmitted light that passes through that phase shifting element in response to the electrical control signal, where each phase shifting element is structured to produce the phase shift that varies with the electrical control signal; and a control circuit coupled to the array of phase shifting elements to apply electrical control signals to the array of phase shifting elements, respectively, one electrical control signal per phase shifting element, the control circuit structured to control the electrical control signals to cause desired phase shifts at the phase shifting elements, respectively, so as to steer and control a direction of the transmitted light. Each phase shifting element includes: a semiconductor cylindrical core protruded above the substrate; a nonlinear optical material formed over the substrate to include a hollow nonlinear optical material cylinder protruded above the substrate to be in contact with and to enclose sidewalls of the semiconductor cylindrical core; and an external metal layer formed on exterior cylindrical side surface of the hollow nonlinear optical material cylinder. The control circuit is coupled to the external metal layer and the semiconductor cylindrical core to apply an electrical control signal to control a phase shift in light that passes through each individual phase shifting element.

In some embodiments, each phase shifting element further includes a metal contact line formed over the substrate to include one terminal to be in contact with the external metal layer to supply the electrical control signal. In some embodiments, the nonlinear optical material formed over the substrate includes a nonlinear optical material layer that covers a surface of the semiconductor substrate that is not covered by the semiconductor cylindrical core and the hollow nonlinear optical material cylinder, where the external metal layer formed on exterior cylindrical side surface of the hollow nonlinear optical material cylinder and the metal contact line are located above the nonlinear optical material layer.

One type of nonlinear optical materials suitable for implementing the above device is plasma enhanced chemical vapor deposition (PECVD) silicon-rich nitride (SRN) materials exhibiting a significant DC-Kerr effect to cause optical phase shifts for beam steering and other optical applications.

In another example aspect, a method for steering, controlling, or scanning an optical beam is disclosed. The method includes directing an optical beam to transmit through a two-dimensional array of phase shifting elements supported by a substrate, where each phase shifting element includes a semiconductor cylindrical core protruded above the substrate; a nonlinear optical material formed over the substrate to include a hollow nonlinear optical material cylinder protruded above the substrate to be in contact with and to enclose sidewalls of the semiconductor cylindrical core, and an external metal layer formed on exterior cylindrical side surface of the hollow nonlinear optical material cylinder. The method further includes applying control voltages to the phase shifting elements, respectively, by applying each control voltage to the hollow nonlinear optical material cylinder via the external metal layer and the semiconductor cylindrical core to cause a phase change in a portion of the optical beam received by a phase shifting element based on a change in a refractive index of the hollow nonlinear optical material cylinder and a surface plasmon condition at an interface of the hollow nonlinear optical material cylinder and the external metal layer. The method further includes controlling the applied control voltages at the different phase shifting elements to cause desired phase shifts at the phase shifting elements, respectively, so as to steer and control the optical beam that transmit through the two-dimensional array of phase shifting elements.

In yet another example aspect, a device for changing a phase of an optical beam includes a semiconductor substrate, a semiconductor pillar supported by the semiconductor substrate, and a nonlinear optical material layer on a top surface of the semiconductor pillar, a sidewall of the semiconductor pillar, and a top surface of the semiconductor substrate that is exposed by and adjacent to the semiconductor pillar. The device further includes a metal layer on a first portion of the nonlinear optical material layer that encloses the semiconductor pillar while exposing a second portion of the nonlinear optical material layer. The device further includes a metal contact on the second portion of the nonlinear optical material layer and in contact with the metal layer. The device further includes an electrical control circuit in connection with the metal contact to supply the device with an electrical control signal, where at least one of the semiconductor pillar and the semiconductor substrate is coupled to a ground, where the device, when operated, interacts with a light travelling through the device to cause the light to undergo a phase shift based on a change in a refractive index of the nonlinear optical material layer and a surface plasmon condition at an interface between the nonlinear optical material layer and the metal layer, and where the device changes a magnitude of the phase shift of the light when an amplitude of the electrical control signal is varied.

The above and other features of the disclosed technology are described in greater detail in the description, the drawings, and the claims.

### BRIEF DESCRIPTION OF THE DRAWINGS

FIG. 1 illustrates an example electro-optical modulator in accordance with one or more embodiments of the present technology.

FIG. 2 illustrates an example electro-optical modulator array in accordance with one or more embodiments of the present technology.

FIG. 3 illustrates another example electro-optical modulator in accordance with one or more embodiments of the present technology.

FIGS. 4 and 5 illustrate example electric field localizations in example electro-optical modulators in accordance with one or more embodiments of the present technology.

FIG. 6 illustrates phase shift for different aspect ratios of example electro-optical modulators in accordance with one or more embodiments of the present technology.

FIG. 7 is a flowchart of a method for fabricating an example electro-optical modulator in accordance with one or more embodiments of the present technology.

FIGS. 8-13 illustrate an example electro-optical modulator at different fabrication stages according to the method in FIG. 7 in accordance with one or more embodiments of the present technology.

FIG. 14 illustrates a setup to characterize an electro-optical modulator in accordance with one or more embodiments of the present technology.

FIG. 15 illustrates a transmission result of an example electro-optical modulator in accordance with one or more embodiments of the present technology.

FIG. 16 illustrates a theoretical model of an example electro-optical modulator in accordance with one or more embodiments of the present technology.

FIG. 17 illustrates transmission results of theoretical resonators in an example electro-optical modulator in accordance with one or more embodiments of the present technology.

FIG. 18 shows a breakdown of the terms of the nonlinear polarization in accordance with one or more embodiments of the present technology.

FIG. 19 shows changes of refractive index under different AC/DC conditions in accordance with one or more embodiments of the present technology.

FIG. 20 illustrates modulated Eac waves as a function of the fraction of Eac/Edc for a fixed Edc in accordance with one or more embodiments of the present technology.

FIG. 21 illustrates an example electro-optical waveguide in accordance with one or more embodiments of the present technology.

FIG. 22 is a flowchart of a method for fabricating an example electro-optical waveguide in accordance with one or more embodiments of the present technology.

FIGS. 23-32 illustrate an example electro-optical waveguide at different fabrication stages according to the method in FIG. 22 in accordance with one or more embodiments of the present technology.

FIG. 33 illustrates modulator parameters as a function of physical characteristics in accordance with one or more embodiments of the present technology.

FIG. 34 illustrates more modulator parameters as a function of physical characteristics in accordance with one or more embodiments of the present technology.

FIG. 35 illustrates modulator performances in accordance with one or more embodiments of the present technology.

FIG. 36 illustrates an example ring resonator in accordance with one or more embodiments of the present technology.

FIG. 37 illustrates transmission spectra as a function of modulator physical characteristics in accordance with one or more embodiments of the present technology.

FIG. 38 illustrates tradeoffs as a function of modulator physical characteristics in accordance with one or more embodiments of the present technology.

FIG. 39 illustrates Mach Zehnder Interferometer parameters as a function of physical characteristics in accordance with one or more embodiments of the present technology.

FIG. 40 illustrates Mach Zehnder Interferometer performances in accordance with one or more embodiments of the present technology.

FIGS. 41-43 illustrate material properties that can be used in an example electro-optical modulator in accordance with one or more embodiments of the present technology.

FIG. 44 illustrates applied electric fields in accordance with one or more embodiments of the present technology.

FIG. 45 illustrates transmission parameters as a function of applied voltage in accordance with one or more embodiments of the present technology.

### DETAILED DESCRIPTION

Nonlinear optical materials with desired electro-optical effects for modulating light in this disclosed technology can be formed over a silicon-based semiconductor substrate using silicon processing compatible fabrication so that the entire device including CMOS circuit components and CMOS circuits can be fabricated together. The selection of the nonlinear optical materials can use materials that exhibit both second and third order nonlinear optical effects due to the Pockels and DC-Kerr effects, respectively. As further explained below, silicon rich nitride (SRN) materials can be attractive candidates for silicon-based processing and silicon-based circuits and devices. Specifically, it has been shown that SRN thin films can exhibit anomalous second order nonlinear susceptibilities and very high third order nonlinear susceptibilities, a high threshold for the breakdown field, and a low optical loss that is desirable for a dielectric waveguiding material. The disclosed optical devices can be used in various applications such as optical modulation on silicon chips and optical beam steering.

Steering, controlling, or scanning an optical beam has versatile applications including various light detection and ranging (LIDAR) systems. Various beam steering or scanning devices use movable components such as movable optical reflectors, rotating mirrors, or optical polygons, and other movable optical devices to change the direction of light. Such beam steering or scanning devices based on movable components are subject to certain technical limitations including tear and wear and reliability issues. Alternatively, two-dimensional (2D) array of phased optical modulators without movable components may be used to perform beam steering or scanning. Some examples are described by Sun, J., Timurdogan, E., Yaacobi, A., Hosseini, E. S., & Watts, M. R. (2013). Large-scale nanophotonic phased array. Nature, 493(7431), 195-199; Xu, Q., Schmidt, B., Pradhan, S. & Lipson, M. Micrometre-scale silicon electro-optic modulator. Nature 435, 325-327 (2005); and Aksyuk, V. A., Dennis, B. S., Haftel, M. I., Czaplewski, D. A., Lopez, D., & Blumberg, G. (2015, June).

Although optical phased arrays are an elegant non-mechanical beam steering approach, the technical and environmental challenges compared to RF systems (10,000 times smaller wavelengths and tolerances) are daunting. The main challenge to construct optical phased array beam steering technology relies on the ability to construct ultra-compact phase shifters with footprint <1 μm² and power consumption <5 μW/2π. Moreover, these phase shifters should enable scalability to large size 2D arrays with period on the order of the wavelength of light to allow wide angular scanning range and at high angular resolution.

Currently, compact chip scale 2D phased array optics are implemented using 2D arrays of phase shifters based on waveguide coupled directional gratings. These devices are based on a photonic architecture in which photonic waveguides feed a linear array of add/drop filters. The amount of coupling into each add/drop filter can be modulated thermally via metal heaters. From the add/drop, the light is passed to a grating nanoantennas which emits the light vertically. Compact 64×64 arrays of phase shifters with a pixel size of 9 μm×9 μm or 89 μm² have been reported. Such approaches are fundamentally limited in pixel size by the size of the waveguide couplers themselves, which due to the physical requirements of wavelength scaling, are necessarily longer than 1 μm. Likewise, the heaters themselves add a non-negligible footprint requirement both in terms of the physical size of the heaters, and the required thermal isolation via distance from nearby pixels. Additionally, the heaters have a limited response time. It may be possible to control coupling in such devices via direct current injection, but even then, that approach would still be limited by the physical size of the waveguide coupler.

The typical 2D beam steering scheme utilizes a phase difference between integrated optical phase shifter for each dimension. However, in order to realize a 2D beam steering the spacing between each component of each shifter needs to be very small to ensure an acceptable field of view. The beam steering angle (Φ) is related the array period (d) by the equation

$$Φ = arcsin ( \frac{Ψλ}{2 π d} ) .$$

Additionally, most of the suggested 2D optical beam steering devices are only tuned in one dimension using a grating antenna, while the second dimension is tuned by shifting the operating wavelength in conjunction with a fixed diffraction grating (thereby changing the diffraction angle). This method greatly limits the field of view in the second dimensions.

To further achieve improved performance metrics of phase shifter arrays for beam forming applications, the technology disclosed in this patent document describes an alternative approach to the design of a large 2D array with sub wavelength spacing by utilizing a hybrid plasmonic modulator.

The technology disclosed in this patent document for optical devices for steering light is based on a unique 2D array of phased optical modulators based on integrated photonic chip fabrication technologies to provide high performance and small footprint device packaging. The phased optical modulators can be phase shifting elements, each of which can be configured as a vertical-cavity surface-emitting phase shifter (VCSEP) to provide effective phase changes via both the control of the optical refractive index of the nonlinear optical material and the metal-dielectric surface plasmon effect.

The technology disclosed in this patent document describes a novel method towards obtaining a 2D beam steering system which could be used for LIDAR applications. The method utilizes a hybrid plasmonic waveguide in a cylindrical topology creating a nanoscale VCSEP. This approach enables a sub-wavelength spacing between each phase shifter and therefore provides a larger field of view. Each VCSEP includes a highly doped sub-micron silicon pillar coated with a thin layer of non-linear material then another layer of conductive metal. The input optical carrier is inserted from the polished back side of the silicon substrate, which is then modulated by the phase shifter and re-emitted in the vertical direction to form a beam in the far field. The hybrid plasmonic localization increases the effective interaction length of the light with the non-linear material within a silicon core resonant cavity. Increased interaction length due to plasmonic effects in the vertical architecture leads to an enhanced phase shift. A lower loss is possible while retaining high localization due to an overlap of photonic mode and plasmonic modes. The impedance mismatch between the vertical hybrid plasmonic waveguide and free space creates a low finesse, low-Q cavity resonator. The single VCSEP device can be considered as a low finesse Fabry-Perot resonator that can be used for phase modulation with less than 3 dB amplitude modulation. The optical response of a single VCSEP with an aspect ratio of 12.5 is characterized, which has an FSR of 47.25±2.5 nm and transmission variation of 3 dB.

The disclosed technology can be implemented to provide an optical beam steering and scanning module that includes an array of phase shifting elements supported by a substrate and spaced from one another to receive light incident to one side of the substrate and to interact with the incident light to produce transmitted light on an opposite side of the substrate. Each phase shifting element is coupled to receive an electrical control signal applied to the phase shifting element and structured to be operable to cause a phase shift on the transmitted light that passes through that phase shifting element in response to the electrical control signal. Each phase shifting element is structured to produce the phase shift that varies with the electrical control signal. A control circuit is coupled to the array of phase shifting elements to apply electrical control signals to the array of phase shifting elements, respectively, one electrical control signal per phase shifting element, the control circuit structured to control the electrical control signals to cause desired phase shifts at the phase shifting elements, respectively, so as to steer and control a direction of the transmitted light. Notably, in implementing the array of phase shifting elements, each phase shifting element includes a semiconductor cylindrical core protruded above the substrate; a nonlinear optical material formed over the substrate to include a hollow nonlinear optical material cylinder protruded above the substrate to be in contact with and to enclose sidewalls of the semiconductor cylindrical core; and an external metal layer formed on exterior cylindrical side surface of the hollow nonlinear optical material cylinder. The control circuit is coupled to the external metal layer and the semiconductor cylindrical core to apply an electrical control signal to control a phase shift in light that passes through each individual phase shifting element.

In some implementations, the above phase shifting element can be configured as a VCSEP where the hollow nonlinear optical material cylinder located between the external metal layer and the semiconductor cylindrical core provide effective phase changes via both the control of the optical refractive index of the nonlinear optical material and the metal-dielectric surface plasmon effect. The VCSEP design may be used for various nonlinear optical materials such as zirconium oxide (ZrO₂), silicon-rich nitrides (SRN), and others based on their electro-optic properties.

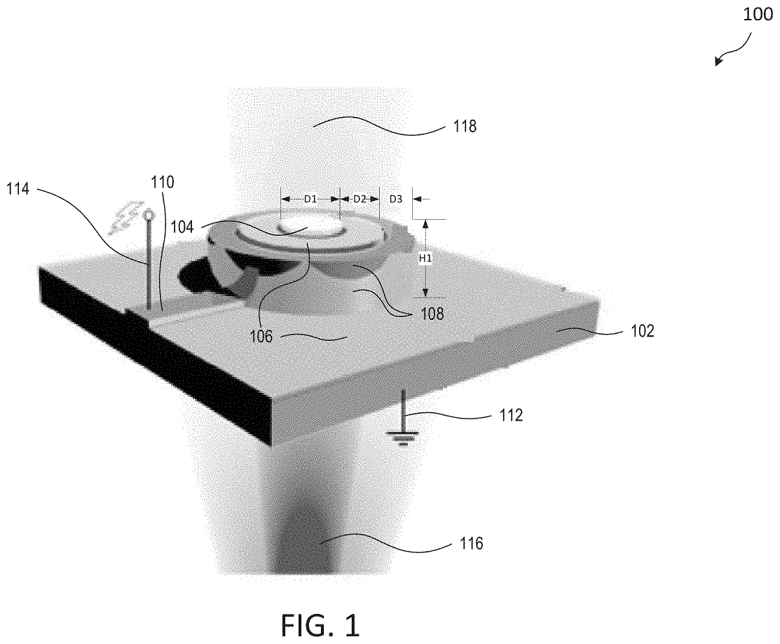

FIG. 1 illustrates an example electro-optical modulator 100 in accordance with one or more embodiments of the present technology. In some embodiments, electro-optical modulator 100 can be a VCSEP. Electro-optical modulator 100 can include a substrate 102. Substrate 102 can include a semiconductor material, such as silicon (Si), germanium (Ge), silicon germanium (SiGe), or gallium arsenide (GaAs). Electro-optical modulator 100 can include a semiconductor pillar 104. Semiconductor pillar 104 can be supported by substrate 102. Semiconductor pillar 104 can include a semiconductor material, such as Si, Ge, SiGe, or GaAs. Semiconductor pillar 104 can have a height H1 between about 0.5 μm and about 20 μm. Semiconductor pillar 104 can have a diameter D1 between about 50 nm and about 1 μm. A ratio H1/D1 can be between about 10 and about 40.

Electro-optical modulator 100 can include a nonlinear optical material layer 106. Nonlinear optical material layer 106 can be formed on a top surface of semiconductor pillar 104, a sidewall of semiconductor pillar 104, and a top surface of substrate 102 that is exposed by semiconductor pillar 104. Nonlinear optical material layer 106 can include zirconium oxide (ZrO₂), tantalum oxide (Ta₂O₅), silicon-rich nitride (SRN), ultra-silicon-rich nitride (USRN), silicon nitride (Si₃N₄), hydrogenated amorphous silicon (a-Si:H), or crystalline silicon (c-Si). Nonlinear optical material layer 106 can have a thickness D2 between about 5 nm and about 200 nm. A ratio D1/D2 can be between about 1 and about 10.

Electro-optical modulator 100 can include a metal layer 108. Metal layer 108 can be formed on a first portion of nonlinear optical material layer 106 that encloses semiconductor pillar 104 while exposing a second portion of nonlinear optical material layer 106. Metal layer 108 can include a conductive metal such as gold (Au), silver (Ag), copper (Cu), or aluminum (Al). Metal layer 108 can have a thickness D3 between about 5 nm and about 200 nm. A ratio D2/D3 can be between about 0.2 and about 5.

Electro-optical modulator 100 can include a metal contact 110. Metal contact 110 can be formed on the second portion of nonlinear optical material layer 106 and in contact with metal layer 108. Metal contact 110 can include a conductive metal such as Au, Ag, Cu, or Al.

Semiconductor pillar 104 and substrate 102 can be coupled to ground 112, and metal contact 110 can be coupled to an electrical control signal 114. Electrical control signal 114 can be supplied by an electrical control circuit. An incident light 116 can be incident on substrate 102 and travel through electro-optical modulator 100. Incident light 116 can undergo a phase shift based on a change in a refractive index of nonlinear optical material layer 106 and a surface plasmon condition at an interface between nonlinear optical material layer 106 and metal layer 108. A resulting emitted light 118 can have the phase shift. By varying an amplitude of electrical control signal 114, a magnitude of the phase shift can be changed and controlled.

In some embodiments, emitted light 118 can also have an intensity shift. Even though electro-optical modulator 100 is shown to be a cylindrical shape, this is not limiting. For example, electro-optical modulator 100 can have a square or rectangular cross-section. In some embodiments, incident light 116 can travel through electro-optical modulator 100 planarly instead of vertically.

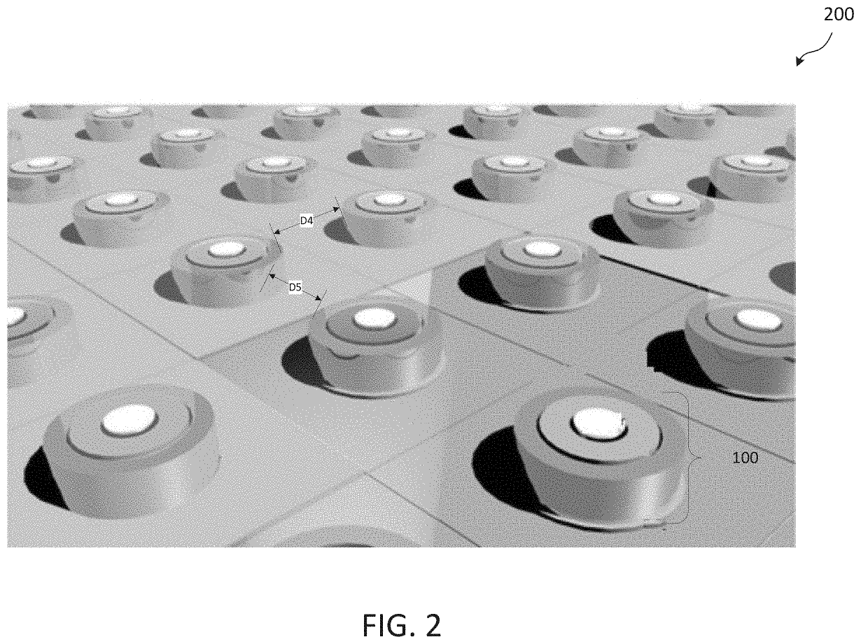

FIG. 2 illustrates an example electro-optical modulator array 200 in accordance with one or more embodiments of the present technology. Electro-optical modulator array 200 can be a number of electro-optical modulator 100 arranged in a pattern. Electro-optical modulator array 200 can have a spacing D4 or D5 between adjacent electro-optical modulators 100 between about 0.5 μm and about 5 μm. A ratio D4/D1 or D5/D1 can be between about 1 and about 10.

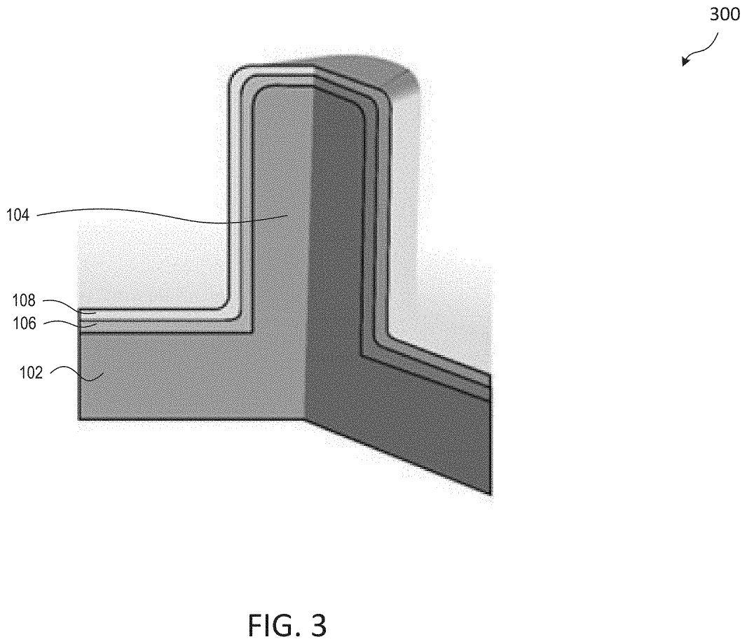

FIG. 3 illustrates another example electro-optical modulator 300 in accordance with one or more embodiments of the present technology. Electro-optical modulator 300 includes substrate 102, semiconductor pillar 104, nonlinear optical material layer 106, and metal layer 108, as described with respect to FIG. 1.

In some embodiments, FIGS. 1 and 2 show an example of an optical beam steering and scanning module in using VCSEPs as the phase shifting elements. FIG. 1 is an example of a VCSEP. Operating in transmission mode, light enters through the bottom, is phase shifted, and exits topside. FIG. 2 shows an example of a VCSEP array. This example of 2D array of hybrid plasmonic resonators uses a structure vertically with respect to the plane of the array or the substrate with input optical carrier inserted from the bottom layer, which is modulated by the phase shifter and re-emitted in the vertical direction to form a beam in the far field.

In some embodiments, FIG. 3 further shows an example of an unfinished VCSEP during the fabrication process. In this example, the VCSEP includes a central silicon pillar on a silicon substrate, a cylindrical nonlinear optical material layer formed from a SRN material, and an external metal coating formed of Au. Referring back to FIG. 1, once the fabrication is completed, the external gold metal coating will be used to apply a control voltage to the VCSEP to control the phase shifting operation.

In some embodiments, the device in FIGS. 1 and 2 utilizes a hybrid plasmonic mode in a composite cylindrical topology resonator device called VCSEP. The VCSEP device footprint is smaller than the wavelength of light in vacuum, enabling a sub-wavelength spacing between them and therefore provides a large field of view (e.g., larger than 120 degrees). Each VCSEP consists of a highly doped submicron silicon pillar (core) coated with a thin layer of nonlinear optical material which is then over coated by a layer of metal with desired plasmonic properties. The VCSEP device realizes a long relatively low Q resonator for the designed hybrid plasmonic mode localized in the nonlinear optical material of the device. The input optical field is inserted from the polished back side of the silicon substrate, which is then modulated by the phase shifter and re-emitted in the vertical direction to form a beam in the far field. When an external voltage is applied to the Si substrate and the plasmonic metal, the introduced electric field across the nonlinear optical material creates a phase shift to the emitted optical field. The hybrid plasmonic mode localization increases the effective interaction length of the light with the nonlinear material within a silicon core resonant cavity. Increased interaction length due to plasmonic effects in the vertical architecture leads to an enhanced phase shift. A lower loss is possible while retaining high localization due to an overlap of photonic mode and plasmonic modes. The impedance mismatch between the vertical hybrid plasmonic waveguide and free space creates a low finesse resulting in a low-Q cavity resonator. In some embodiments, a single VCSEP device is designed and fabricated with an aspect ratio of 12.5. The VCSEP device is characterized with an optical response of corresponding to free spectral range (FSR) of about 45-50 nm with transmission variation of <3 dB.

In some implementations, the example device in FIGS. 1 and 2 can use a hybrid plasmonic waveguides with a nonlinear material such as ZrO₂ in vertical cylindrical topology coupling directly to free space (see FIG. 1). These VCSEPs can be used to realize full 2π phase shift at a packing density ≥1/μm². Specifically, arrays of VCSEPs will be fabricated on a wafer or a chip and illuminated from below. When light passes through the VCSEPS it will be converted to a hybrid plasmonic mode where it will be localized and pass through a nonlinear material. Through combined localization and resonant effects, the interaction length will be greatly increased. A voltage will be applied to the metal shell via a metal contact (see FIG. 1), and the doped Si core attached to a doped Si substrate will serve as the ground. This will induce an electric field within the nonlinear electro-optical material within the VCSEP, modulating the refractive index within an individual VCSEP pixel. The combination of greater effective interaction length and modulating refractive index within the cavity will achieve a phase shift. The light will then be re-emitted into free space. In this configuration the VCSEP operates in transmission mode.

Implementations of the above design can leverage past experience in design. Modeling, fabrication, and characterization of similar vertical-cavity photonic resonators such as light emitters will allow the fabrication of large arrays of phase modulators/shifters as depicted in FIG. 2 using proven fabrication techniques.

In some embodiments, electro-optical modulator 100, electro-optical modulator array 200, and electro-optical modulator 300 can be hybrid plasmonic modulators. Hybrid plasmonic modulators combine the advantages of photonic and plasmonic structures. These hybrid plasmonic waveguides include a thin noble metal layer, typically on the order of 20 nm thick, sitting atop a thin layer of non-linear dielectric, which in turn sits atop a traditional silicon photonic waveguide. The result is a structure where the photonic mode is “pulled” out of the Si waveguide by the noble metal and is located predominantly in the non-linear dielectric layer between the Si and the noble metal. Critically, pulling a mode out of a photonic waveguide via a metal layer, rather than using a traditional metal-dielectric-metal plasmonic guiding structure, reduces the interaction area between the mode and the lossy metal while still retaining most of the plasmonic localization. This reduces loss to be between 800 to 2000 dB/cm while still supporting localized higher k-vector plasmonic modes. As a further advantage, the resulting mode sits almost entirely in the non-linear material.

In some embodiments, hybrid plasmonic resonators are realized vertically with the input optical carrier inserted from an integrated bottom layer, which is modulated by the phase shifter and re-emitted in the vertical direction to beam form in the far field, as seen in FIG. 1. The VCSEP in FIG. 1 can be operating in transmission mode, where light enters through the bottom, is phase shifted, and exits topside. When light passes through the VCSEPs, it will be converted to a hybrid plasmonic mode where it will be localized and pass through a non-linear material. Through combined localization and resonant effects, the effective interaction length will be greatly increased. A voltage will be applied to the metal shell via a metal contact, and the doped Si core attached to a doped Si substrate will serve as the ground. This will induce an electric field within the non-linear electro optic material within the VCSEP, modulating the refractive index within an individual VCSEP device. The combination of greater effective interaction length and modulating refractive index within the cavity will achieve a phase shift. The light will then be re-emitted into free space. In this configuration the VCSEP operates in transmission mode.

VCSEPs use hybrid plasmonic localization to increase effective interaction length of the light with the non-linear material within the resonant cavity, thus increasing the interaction length due to the plasmonic effect. Lower loss (˜1000 dB/cm) is possible while retaining high localization due to overlap of photonic mode and plasmonic modes. Furthermore, the impedance mismatch between the vertical hybrid plasmonic waveguide and free space will create a low finesse, low-Q cavity resonator.

By utilizing a low-Q cavity the traditional limitations on bandwidth and spectral range found in a high Q photonic resonator-based modulator is reduced, while still gaining interaction length due to a cavity finesse of 10-20. This effect is then compounded with large k-vector plasmonic modes that are localized in space: hybrid plasmonic modes stimulated by a free space 1550 nm laser will have an effective wavelength that is up to 20× shorter in the hybrid plasmonic structure. Combined with an example cavity Q of 10, i.e., assuming a photon will, on average, make 10 round trips through the cavity, the VCSEP will provide a 400× increase in effective interaction length with the non-linear material. In other words, a 5 μm tall VCSEP may have an effective interaction length of 2000 μm or 2 mm with the non-linear materials.

The above example in FIGS. 1 and 2 provides a new concept for realization of phase shifters utilizing hybrid resonance structures in cylindrical topology. Novel design and simulation tools as well as nanofabrication procedures are developed. Devices with aspect ratios of 15:1 with diameters less than 1 μm (footprint <1 μm²) enabling dense integration of VCSEP devices to achieve the ultimate goals of LIDAR application of having a wide angular scanning range (˜120 degrees) with high resolution (˜0.5 degree) in 2D are demonstrated. A specific characterization and testing system are constructed. Novel approaches that led to characterization of spectral response of a single VCSEP device are developed.

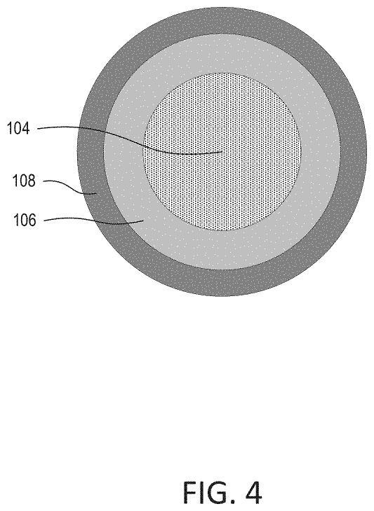

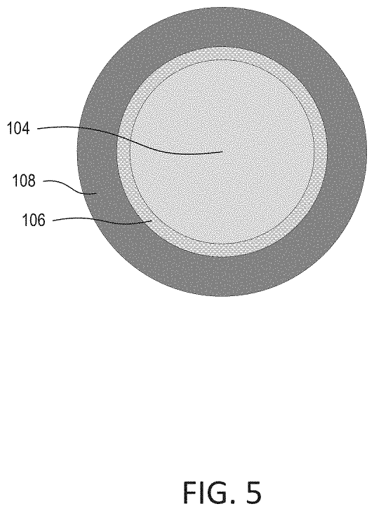

FIGS. 4 and 5 illustrate example electric field localizations in example electro-optical modulators in accordance with one or more embodiments of the present technology. The electro-optical modulators include semiconductor pillar 104, nonlinear optical material layer 106, and metal layer 108, as described with respect to FIG. 1. FIG. 4 illustrates a cylindrical mode, where the electric field is localized in semiconductor pillar 104, such as a Si core. FIG. 5 illustrates a hybrid plasmonic mode, where the electric field is localized in nonlinear optical material layer 106.

In some embodiments, the Lumerical finite-difference time-domain (FDTD) mode simulations of the vertical cylindrical hybrid plasmon cavity (diameter 400 nm) shown in FIGS. 1-3 can be illustrated by FIGS. 4 and 5, with the estimated loss of 2000 dB/cm.

In some embodiments, FIGS. 4 and 5 show simulation for different configurations for the VCSEP and corresponding E-field localization. This particular VCSEP can be formed from a silicon pillar on a silicon substrate with a cylindrical nonlinear optical material layer formed from ZrO₂ and an external cylindrical shaped metal coating formed of Au. As the radius of the Si core approaches the inner radius of the Au metal shell, the mode becomes increasingly localized in the ZrO₂. In this fashion, it is possible to control the amount of light localized in the Si core, the amount of light localized in the ZrO₂, and the amount of light interacting with the Au metal shell. Thus, plasmonic localization, loss, and non-linear interaction can be controlled.

In one example, a VCSEP structure is assumed to be 5 μm long with core Si pillar surrounded with ZrO₂ covered with metal (i.e., Si nanowires can be etched or grown to aspect ratios of 1:20). If λ_{eff_hybrid_plasmon}=λ_{free_space}/20, then the hybrid plasmon mode will see the VCSEP as being 5 μm/(1.550 μm/20), which is 64 wavelengths long. The transverse electromagnetic (TEM) mode of the hybrid plasmonic VCSEP has an effective refractive index of 18.1. It is possible to estimate the finesse of the cavity using the following expressions:

$$F = \frac{{e}^{- α totd / 2}}{1 - {e}^{- α totd}}$$

in which the total optical loss αₜₒₜ is expressed as:

$$α tot = αint + \frac{1}{2 d} ln ( \frac{1}{R 1} \frac{1}{R 2} )$$

wherein the coefficient αᵢₙₜ˜1000 dB cm⁻¹ is the contribution of the metal loss and the last term of αₜₒₜ corresponds to contribution of the mirrors. For a cavity height of d=5 μm, the total loss is αₜₒₜ˜3310 dB cm⁻¹ corresponding to F˜8.

On average, photons will pass through ˜450λ_{eff_hybrid_plasmon} in ZrO₂. Then the electrically induced Δn=0.00104 due to the Kerr effect in the ZrO₂ layer will induce a phase shift of Δφ=71 Provided the Si nanowires can have an aspect ratio of 1:20, it is estimated that for a 0.5 um diameter, a length of 10 um is feasible. With such geometry, the required Δn=0.00052. For such device, it is estimated that a Joules insertion loss is about 1 dB.

The VCSEP couples photonic modes to plasmonic modes through a lower index dielectric (e.g. SiNx) surrounding a high index core (e.g., Si) of the coaxial structure illustrated in FIG. 1. Taken together in a vertical topology, this hybridizes the advantages of plasmonic localization with a low loss photonic mode, where metal also provides the electrical contact in an ultra-compact vertical topology. The electric field localizations are shown in FIGS. 4 and 5. Due to vertical architecture, the suggested VCSEP design can have a very large packing density, ≥1/μm². Flexibility in hybrid plasmonic design allows for optimizing for low loss (<1000 dB/cm) or high localization (e.g., k mode >30 k0 where k0 is the wavevector in free space), depending on the respective radii of the Si core, the interstitial layer of non-linear dielectric, and the metal shell. With a thick Si core and metal cladding, the photonic mode is localized in the silicon core which reduces the propagation losses, as shown in FIG. 4. With a thin Si core, the field is well confined in the non-linear dielectric and strongly localized in a thin section between the metal and the Si core creating greater overall interaction with the non-linear dielectric while retaining some plasmonic localization of non-linear dielectric at the expense of increased loss, as shown in of FIG. 5. This would be the closest to a direct cylindrical analogue to the hybrid plasmonic waveguides, as shown in FIG. 1.

Lumerical FDTD mode simulations of the vertical cylindrical hybrid plasmon cavity with a diameter of 400 nm are shown in FIGS. 4 and 5. The simulated structure is estimated to have a loss of 2000 dB/cm.

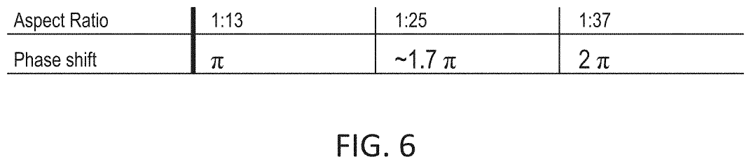

FIG. 6 illustrates phase shift for different aspect ratios of example electro-optical modulators in accordance with one or more embodiments of the present technology.

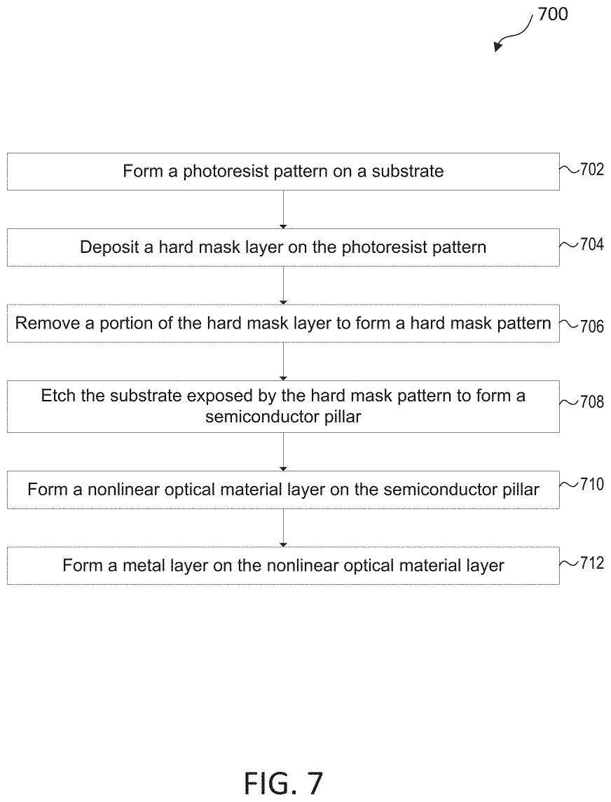

FIG. 7 is a flowchart of a method 700 for fabricating an example electro-optical modulator in accordance with one or more embodiments of the present technology. In some embodiments, method 700 can be used to fabricate electro-optical modulator 100. In some embodiments, the operations of method 700 may not be performed in the order shown in FIG. 7. In some embodiments, not all operations may be needed. In some embodiments, additional operations may be needed.

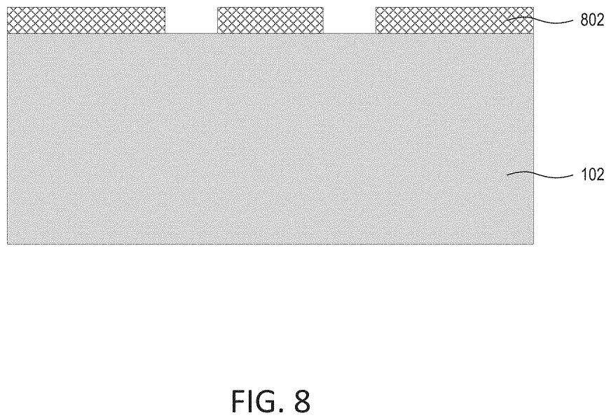

FIGS. 8-13 illustrate an example electro-optical modulator at different fabrication stages according to the method in FIG. 7 in accordance with one or more embodiments of the present technology. The elements in FIGS. 8-13 with the same annotations with those in FIG. 1 are described with respect to FIG. 1.

At operation 702, a photoresist pattern is formed on a substrate. Referring to FIG. 8, a photoresist pattern 802 is formed on substrate 102. In some embodiments, a 500 nm PMMA layer can be spin coated on substrate 102. An E-beam writing can be performed using Vistec EBPG 5200 with a dose of 1500 μC/cm² to direct write photoresist pattern 802. Photoresist pattern 802 can include different circle diameters ranging from 300 to 400 nm. The separation distance between each VCSEP can vary from 1 μm to 13 μm, on different groups of structures.

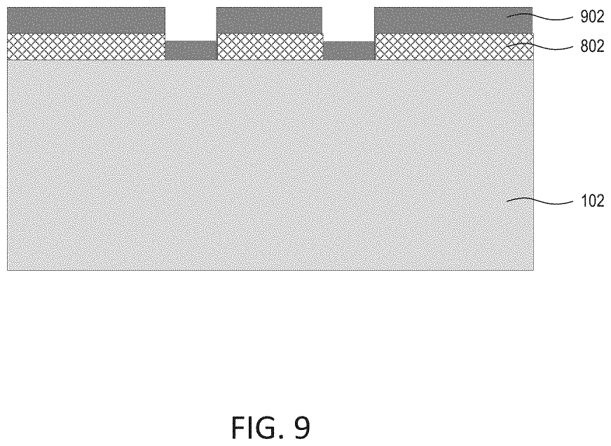

At operation 704, a hard mask layer is deposited on the photoresist pattern. Referring to FIG. 9, a hard mask layer 902 is deposited on photoresist pattern 802. In some embodiments, aluminum oxide (Al₂O₃) can be sputtered onto photoresist pattern 802 to act as hard mask layer 902. Al₂O₃ can have a selectivity of 70,000:1 to Si, which is the best choice for difficult fabrication procedures. In some embodiments, a 5 nm layer of Al₂O₃ can be RF sputtered using Denton Discovery 635 Sputter System. The chamber pressure can be kept at 3.18 mTorr and the RF power can be set to be 400 W.

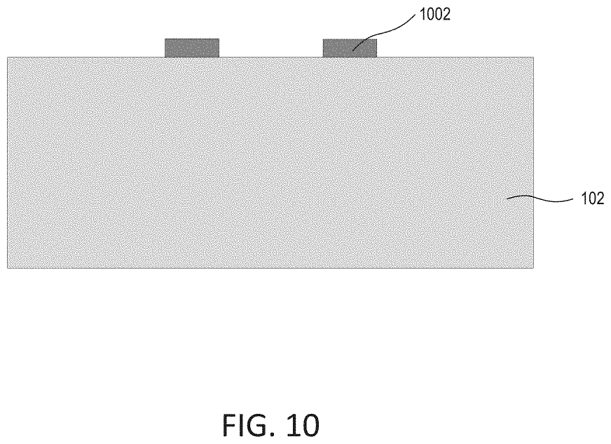

At operation 706, a portion of the hard mask layer is removed to form a hard mask pattern. Referring to FIG. 10, a portion of hard mask layer 902 is removed to form a hard mask pattern 1002. In some embodiments, a lift off process can be performed to remove photoresist pattern 802 and the portion of hard mask layer 902 on top of photoresist pattern 802, resulting in hard mask pattern 1002.

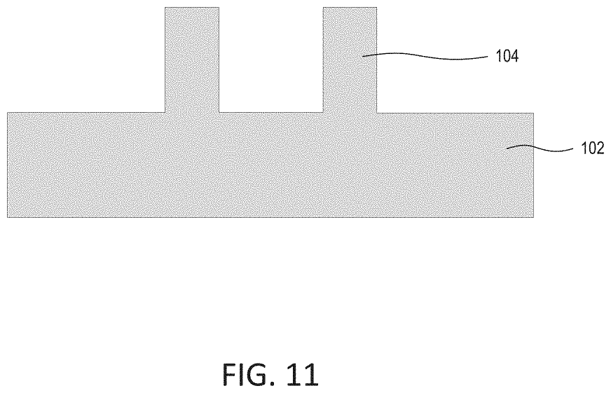

At operation 708, the substrate exposed by the hard mask pattern can be etched to form a semiconductor pillar. Referring to FIG. 11, substrate 102 exposed by hard mask pattern 1002 can be etched to form semiconductor pillar 104. In some embodiments, substrate 102 exposed by hard mask pattern 1002 can be etched with a single-step deep reactive ion etching (SDRIE). In some embodiments, the SDRIE can be performed by the Oxford Plasmalab 100 using a highly controlled etching recipe that maintains smooth walls and has a high etching rate (200 nm/min). The VCSEP pillars etching can be executed by a combination of SF₆/Ar plasma with the addition of C₄F₈ to protect the sidewalls of the pillars by the deposition of an organic polymer. The flow rate of both the SF₆ and C₄F₈ gases can be kept at 28 sccm and 52 sccm, respectively. During the etching process, the chamber pressure can be maintained to be 19 mTorr. The RIE and ICP generated power can be kept at 9 W and 850 W, respectively. In some embodiments, the height of semiconductor pillar 104 can be formed to be between about 1 μm and about 10 μm with an aspect ratio of 10. Afterward, hard mask pattern 1002 can be removed by leaving the device in a chemical etchant, Buffered Oxide Etch (BOE), for 10 seconds with an etching rate of 1 nm/sec. To ensure all the polymer is removed, the device is cleaned with piranha mixture (H₂SO₄:H₂O₂ 3:1) at a temperature of 80° C.

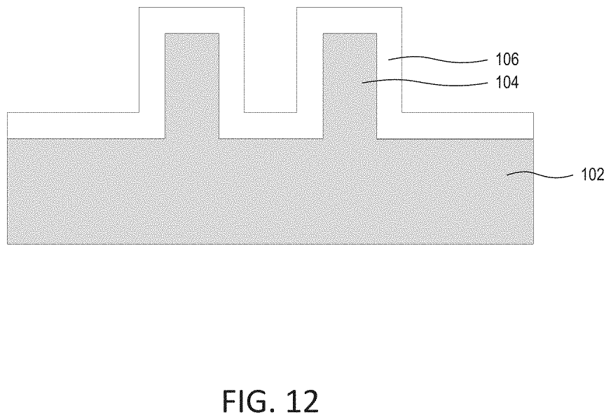

At operation 710, a nonlinear optical material layer is formed on the semiconductor pillar. Referring to FIG. 12, nonlinear optical material layer 106 is formed on semiconductor pillar 104. In some embodiments, nonlinear optical material layer 106 can be SRN. The Oxford PECVD can be used to coat the VCSEP pillars with SRN. During the process, the chamber pressure can be kept at 15 mTorr and RF power can be kept at 50 W. The SRN can be deposited using a combination of SiH₄ and N₂. In some embodiments, SiH₄ can have a flow rate of 450 sccm. In some embodiments, N₂ can have a flow rate of 200 sccm. The important aspect of the recipe is the ratio of SiH₄ flow to N₂ flow which dictates the linear refractive index. In some embodiments, NH₃ is removed from the deposition mixture because it can introduce un-wanted N—H bonds which have absorption peaks near 1550 nm.

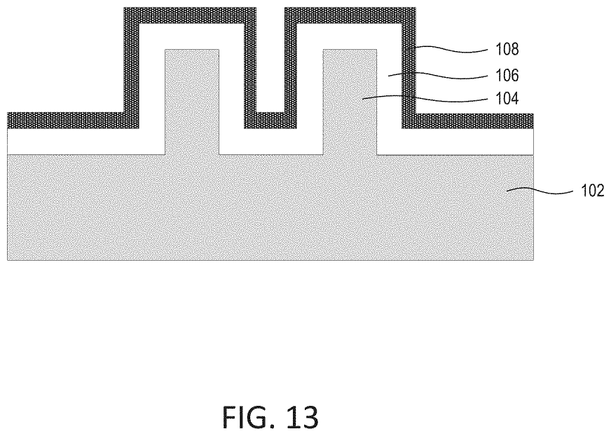

At operation 712, a metal layer is formed on the nonlinear optical material layer. Referring to FIG. 13, metal layer 108 is formed on nonlinear optical material layer 106. In some embodiments, metal layer 108 can be Au. In some embodiments, the pillars can be sputter coated with a thin film of Au using the Denton 635. The chamber pressure can be maintained at 2.88 mTorr during the sputtering process. The DC plasma power can be kept at 200 W for 55 seconds to obtain a Au thickness of 40 nm. To ensure a uniform coating of Au, the stage can be rotated at 10 rpm.

In some embodiments, VCSEP devices can be fabricated from Si wafers. A Si wafer can be first polished on both sides and then a desired patterned mask layer can be formed over the Si wafer. Next, an etching process can be performed (e.g., Inductively Coupled Plasma-Reactive Ion Etching (ICP-RIE) etching) over the mask-covered Si wafer to pattern the silicon to form an array of Si pillars. A layer of a nonlinear optical material (e.g., a SRN layer) can be deposited over the Si pillars and exposed wafer surface. This creates a cylindrical nonlinear optical material layer over each Si pillar. A metal layer such as Au can be subsequently deposited. FIG. 3 shows an example of the structure of one VCSEP in such a VCSEP array structure before additional fabrication steps are performed to form the final VCSEP structure shown in FIG. 1.

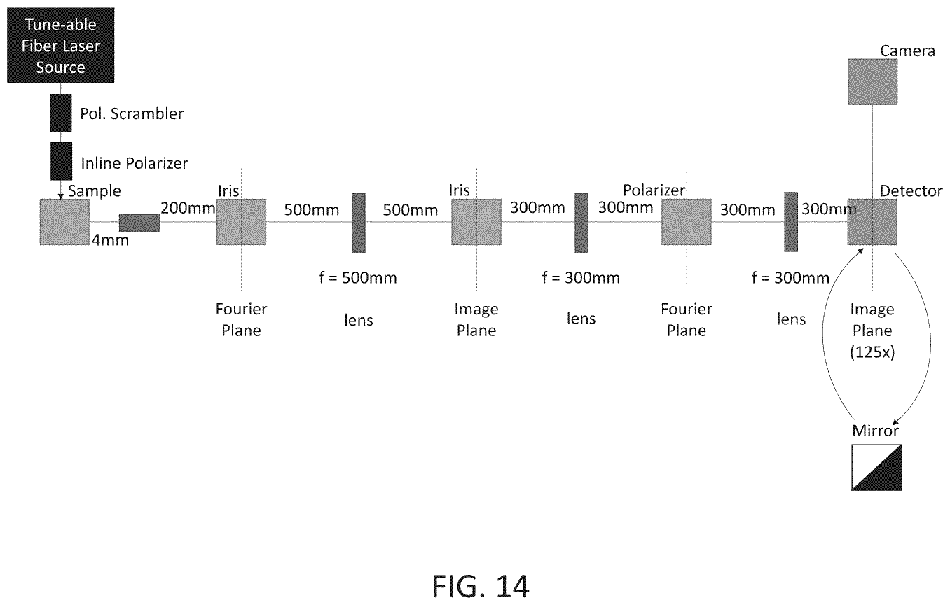

FIG. 14 illustrates a setup to characterize an electro-optical modulator in accordance with one or more embodiments of the present technology. The characterization of the VCSEP can be carried out using the setup as shown in FIG. 14. A laser source (e.g., Agilent model 81980A) is fiber coupled and then collimated before the light is transmitted through the back end of the VCSEP. The tunable laser can have a tuning range from 1460 nm to 1640 nm. The transmitted light is collected by a 0.5 NA microscope objective and projected onto a camera by magnification setup which include lenses, acting as two sequential telescopes with a total magnification of 125. The camera has a 25 μm-by-25 μm pixel size. The camera can be an infrared (IR) camera with 1550 nm illumination. Optical image detected by the IR camera can show transmission of optical field through the single VCSEP device. An iris can be used in the first image plane of the optical setup in order to isolate a single VCSEP structure. This spatial filter limits any unwanted noise that might affect the device measurements. Using the iris to limit the illuminated area can enable measurement to be as close as possible to the VCSEP illuminated area.

In some embodiments, due to the ˜1 μm size of an individual VCSEP, locating the correct structure can be challenging. To simplify the characterization method, the device can be fabricated with large alignment marks, to identify the small area where a single VCSEP or pair of VCSEPs are located.

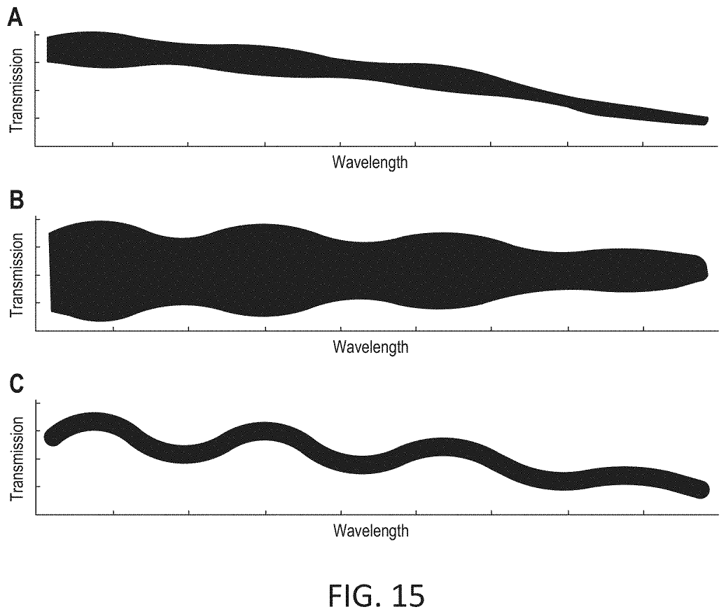

FIG. 15 illustrates a transmission result of an example electro-optical modulator in accordance with one or more embodiments of the present technology. Result A shows a transmission spectrum of the VCSEP device as measured transmittance vs wavelength. In some embodiments, the transmission spectrum of the air-silicon wafer-air and the air-silicon wafer-VCSEP have a FSR of about 1 nm. Result B shows the Spectra-normalized data. Result B takes into consideration the power spectra of the source and the effect of spectra on coupling efficiency. Result C shows a Hilbert Transform of the data showing the VCSEP response with expected FSR. The Hilbert Transform removes the fast oscillations due to wafer resonance and obtains a curve corresponding to transmission of a single VCSEP device. It is estimated that the optical response of a single VCSEP device with an aspect ratio of 12.5 can have an FSR of 47.25±2.5 nm and a transmission variation of 3 dB.

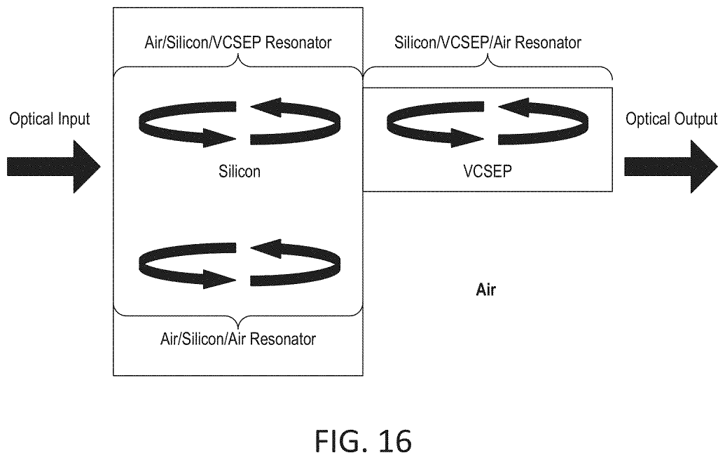

FIG. 16 illustrates a theoretical model of an example electro-optical modulator in accordance with one or more embodiments of the present technology. To further understand the analyzed structure, each single VCSEP device can be considered as a sequence of Fabry-Perot resonators with three different resonators defined in the VCSEP theoretical model as shown in FIG. 16. The first one include an air-silicon wafer-VCSEP resonator, the second one includes an air-silicon wafer-air resonator, and the third resonator includes a silicon wafer-VCSEP-air resonator. Different resonators can affect the transmission spectrum of the fabricated VCSEP. Identifying the resonance response of each resonator is necessary to understand the results obtained from characterizing the single VCSEP device, since the transmitted optical spot size is larger than the diameter of an individual VCSEP device and therefore, the measured result corresponds to the response of these three resonators.

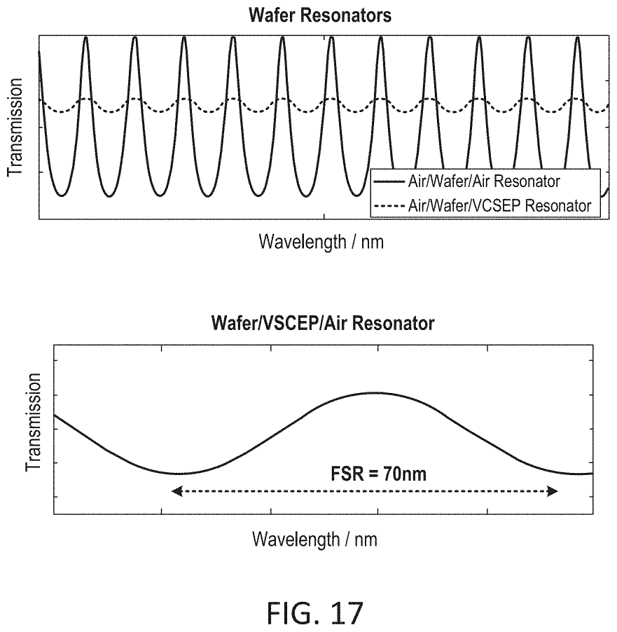

FIG. 17 illustrates transmission results of theoretical resonators in an example electro-optical modulator in accordance with one or more embodiments of the present technology. The response of the air-silicon wafer-VCSEP resonator, the air-silicon wafer-air resonator, and the silicon wafer-VCSEP-air resonator and their Free Spectral Ranges (FSRs) are depicted in FIG. 17.

This patent document introduces a novel approach for the realization of phase shifters utilizing hybrid resonance structures in a cylindrical topology. This new approach offers a compact architecture for integrated scanners useful for LIDAR applications. This patent document also shows a novel design and simulation tools as well as nanofabrication procedures and demonstrates fabricated devices with aspect ratios as high as 15:1 with diameters less than 1 μm (footprint <1 μm²) enabling dense integration of VCSEPs. Such a small footprint makes it possible to achieve the high density required for wide angular bandwidth scanning with high resolution across a large area. The constructed optical setup can be used to characterize the optical response of a single VCSEP device. The transmission spectrum is obtained by sweeping the laser source from 1460 nm to 1640 nm and it can be noticed that the transmission power is reduced as the wavelength increases. This is due to coupling efficiency and this effect can be eliminated by normalizing the transmission spectrum. The envelope of the spectrum can be obtained by applying a Hilbert Transform function, thus it is estimated that the response of a single VCSEP with an aspect ratio of 12.5 can have an estimated FSR of 47.25±2.5 nm and transmission variation of 3 dB.

Various implementations of optical devices can be provided based on the VCSEP design. For example, a device for changing a phase of an optical beam can be structured to include a semiconductor substrate; a semiconductor pillar supported by the semiconductor substrate; a nonlinear optical material layer on a top surface of the semiconductor pillar, a sidewall of the semiconductor pillar, and a top surface of the semiconductor substrate that is exposed by and adjacent to the semiconductor pillar; a metal layer on a first portion of the nonlinear optical material layer that encloses the semiconductor pillar while exposing a second portion of the nonlinear optical material layer; a metal contact on the second portion of the nonlinear optical material layer and in contact with the metal layer; and an electrical control circuit in connection with the metal contact to supply the device with an electrical control signal, where at least one of the semiconductor pillar and the semiconductor substrate is coupled to a ground. This device, when operated, interacts with a light travelling through the device to cause the light to undergo a phase shift based on a change in a refractive index of the nonlinear optical material layer and a surface plasmon condition at an interface between the nonlinear optical material layer and the metal layer, and the device changes a magnitude of the phase shift of the light when an amplitude of the electrical control signal is varied. In some implementations of the above device, a ratio between a height of the semiconductor pillar and a diameter of the semiconductor pillar is between about 10 and about 40, a ratio between the diameter of the semiconductor pillar and a thickness of the nonlinear optical material layer is between about 1 and about 10, and a ratio between the thickness of the nonlinear optical material layer and a thickness of the metal layer is between about 0.2 and about 5. In some implementations, the above device can include other similarly described structures to form an array of phase shifting elements, and a spacing between adjacent phase shifting elements is between about 0.5 μm and about 5 μm, and where a ratio between the spacing and a diameter of the semiconductor pillar is between about 1 and about 10. In some implementations of the above device, the semiconductor substrate can include silicon (Si), germanium (Ge), silicon germanium (SiGe), or gallium arsenide (GaAs), the semiconductor pillar can include Si, Ge, SiGe, or GaAs, and the nonlinear optical material layer can include zirconium oxide (ZrO₂), tantalum oxide (Ta₂O₅), silicon-rich nitride (SRN), ultra-silicon-rich nitride (USRN), silicon nitride (Si₃N₄), hydrogenated amorphous silicon (a-Si:H), or crystalline silicon (c-Si). The metal layer in the above can include gold (Au), silver (Ag), copper (Cu), aluminum (Al), or chromium (Cr), and the metal contact can include Au, Ag, Cu, Al, or Cr. In some implementations, the electrical control signal of the above device may include a direct-current (DC) component and an alternating-current (AC) component, and a magnitude of the DC component is at least 10 times greater than that of the AC component.

This patent document further discloses designs of optical devices based on linearized [symbol] ⁽³⁾ based electro-optic modulation using the quadratic third order DC-Kerr effect. The examples for such optical devices include a linearized [symbol] ⁽³⁾ phase modulator utilizing SRN where it is shown that a phase modulator with a V_{π}L_{π} metric as low as 2 Vcm or with a V_{π}L_{π}α metric as low as 116 VdB is achievable and a V_{π}L_{π} can be as low as 1 Vcm in a push-pull Mach Zehnder Interferometer. This numerical study shows that linearized modulation exploiting the [symbol] ⁽³⁾, and [symbol] ⁽²⁾ as applicable, is possible and can allow for high-speed modulation using a CMOS compatible material platform.

Optical interconnects form a major part of the disruptive impact of integrated optical systems in a variety of applications and therefore have driven continued interest in finding the next generation of optical modulators. Historically, high-speed optical modulators have relied upon lithium niobate where thanks to the lithium niobate on insulator platform V_{π}L_{π} metrics on the order of 1.8 Vcm have been achieved, while in search of higher efficiencies other high-k dielectrics have been considered such as barium titanate. All of these materials have three primary issues. First, they are in general not CMOS compatible making fabrication more expensive compared to a CMOS process which can be done by a foundry. Second, they have low refractive indices compared to silicon requiring larger waveguide cross-sections to achieve reasonable mode-confinement. Third, they all have higher RF permittivity leading to smaller electric fields in the same cladding at the same applied voltage. As a result, many optical interconnects still utilize carrier dispersion in silicon waveguides and so there remains interest in a CMOS compatible alternative to such techniques that can disrupt optical modulators in CMOS manufacturing. The issue remains however, that most CMOS compatible materials either do not exhibit a [symbol] ⁽²⁾, or exhibit a negligible small one such as lower index stoichiometric silicon nitride films. SRN films can not only exhibit non-zero [symbol] ⁽²⁾ but that their refractive index, thermo-optic coefficient, as well as [symbol] ⁽²⁾ and [symbol] ⁽³⁾ are all enhanced with increasing silicon content and that this is true even in the case of low temperature PECVD-based SRN films. In this patent document, a systematic evaluation of the contributions from second and third order nonlinearities in arbitrary materials is disclosed and a case for a [symbol] ⁽³⁾ based linearized electro-optic modulator utilizing a form of heterodyne gain is described. A numerical study of such a modulator is disclosed, designing phase-type modulator based on SRN film properties, achieving V_{π}L_{π} metrics from 1 to 1.8 Vcm and V_{π}L_{π}α metrics of 37 VdB as a phase modulator, or as low as 1 Vcm in a push-pull Mach Zehnder Interferometer intensity modulator. The integration of such a phase-shift element into a ring resonator cavity as an intensity modulator is described. With proper cavity design and allowing for a degree of coupling miss-match, extinction ratios between 12 dB and 20 dB are achievable. Some discussion on the inherent tradeoffs with such a design is disclosed. A linearized [symbol] ⁽³⁾ based modulator can serve as a viable CMOS compatible alternative to use materials lacking [symbol] ⁽²⁾ nonlinearities, and as a pure phase modulator alternative to traditional plasma-dispersion approaches in silicon.

A brief analysis of second and third order nonlinear optical effects in nonlinear materials with emphasis on the presence of an applied external electric fields is described. Effects of higher order nonlinearities, beyond that of [symbol] ⁽³⁾ alone, are considered, as research has shown that most CMOS compatible materials lack a [symbol] ⁽²⁾ as a result of their crystal symmetry. Induced polarization can be written as follows:

P(r,t)=ϵ₀[ [symbol] ⁽¹⁾E(r,t)+ [symbol] ⁽²⁾E²(r,t)+ [symbol] ⁽³⁾E³(r,t)+ . . . ] (1)

In equation 1, [symbol] ⁽¹⁾, [symbol] ⁽²⁾ and [symbol] ⁽³⁾ represent the first, second and third order nonlinear susceptibilities respectively and are treated as tensors of rank two, three, and four, respectively. This is a useful formalism because both modulation and wave mixing are understood as solutions to the nonlinear form of Maxwell's equation. If the total electric field E(r, t) is allowed to be a sum of an optical wave (E_{ω}) and applied electric field (electro-static E_{dc} and time-varying E_{ac}), expressions for the contributions to the nonlinear portion of the induced polarization can be derived, grouping and simplifying terms based on their contributions. Below, as an example, three first terms of equation 1 expansion are shown, grouped and labeled with various nonlinear effects.

$$( 2 )$$

$${P}_{NL} = \frac{\frac{Electrostatic}{\begin{matrix}{ϵ}_{0} \{ {X}^{( 2 )} [ 2 {EE}^{\text{?}} + {E}_{dc}^{2} ] + \\ + {χ}^{( 3 )} [ ( 3 {E}_{ac}^{2} E + 3 {E}^{2} {E}^{\text{?}} ) {e}^{- j ωτ} +\end{matrix}} \frac{Pockels}{\begin{matrix}{χ}^{( 2 )} [ 2 {E}_{dc} {Ee}^{- j ωτ} + 2 {E}_{dc} {E}^{′} {e}^{j ωτ} + \\ ( 3 {E}_{dc}^{2} {E}^{\text{?}} + 3 {EE}^{‵2} ) {e}^{j ωτ} +\end{matrix}}}{Kerr effect and DC - induced Pockels} \frac{\frac{SHG}{\begin{matrix}{χ}^{( 2 )} [ {E}^{2} {e}^{- j 2 ωτ} + {E}^{- 2} {e}^{j 2 ωτ} ] + \\ {χ}^{( 3 )} [ 3 {E}_{dc} {E}^{2} {e}^{- j 2 ωτ} + 3 {E}_{dc} {E}^{•2} {e}^{j 2 ωτ} ] +\end{matrix}}}{EFISHG} \frac{\frac{Electrostatic}{\begin{matrix}{χ}^{( 3 )} [ {E}_{ac}^{3} + 6 {EE}^{′} {E}_{dc} ] \\ {χ}^{( 3 )} [ {E}^{2} {e}^{- j 2 ωτ} + {E}^{•3} {e}^{j 2 ωτ} ] \}\end{matrix}}}{THG}$$

$$\text{?} \text{indicates text missing or illegible when filed}$$

This represents a subset of the possible terms in the nonlinear polarizability, due to the specific choice of terms in the total electric field and additionally the tensorial notation has been suppressed here for simplicity. The terms present in this expansion relate to the various forms of nonlinear processes that utilize the susceptibility.

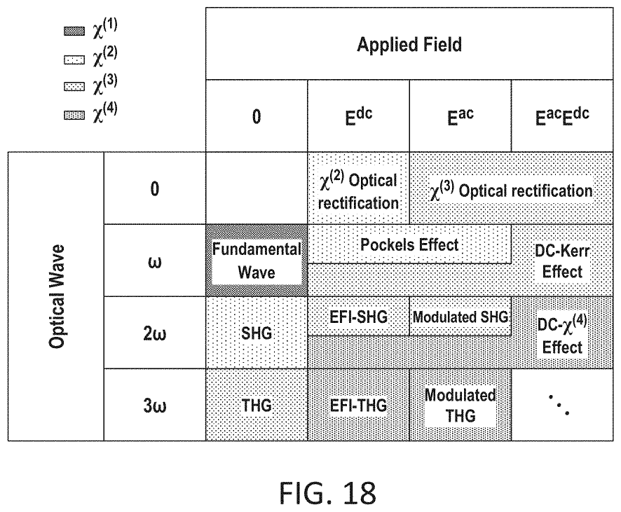

FIG. 18 shows a breakdown of the terms of the nonlinear polarization in accordance with one or more embodiments of the present technology. The breakdown of the terms can be based on the combination of optical wave and applied field present in the induced polarization. The items in FIG. 18 can be thought of as falling into one of two different categories: (1) effects at the fundamental optical frequency—switching and modulation and (2) effects at harmonic frequencies (including 0 frequency)—wave mixing. Switching and modulation based on the nonlinear susceptibility is typically thought to include the Pockels effect and the Quadratic Electro-optic effect, sometimes called the DC-Kerr effect, whereas wave mixing includes three and four wave mixing, active and passive. However, terms such as the “EFI-SHG” (here EFI stands for electric field induced) and “Modulated SHG” blur this distinction and can allow methods for both enhancing second order processes as well as analyzing third order nonlinearities via three-wave mixing. Importantly, if a combination of electro-static E_{dc} and time-varying E_{ac} together with the optical E_{ω} is allowed, a term (last column in FIG. 18) can be derived which allows for third order based linear modulation. This is of especially interest to explore, as unlike [symbol] ⁽²⁾ which is dependent on crystal structure, [symbol] ⁽³⁾ is present in all materials. In the remainder of this patent document, only non-resonant electronic nonlinearities are considered as this type of nonlinearity can respond at ultra-fast speeds and is thus of interest for high-speed modulation, as well as be useful for wave-mixing applications. In the following, the case of an arbitrary material which has some set of [symbol] ⁽²⁾ and [symbol] ⁽³⁾ tensors is considered, under the presence of an applied electric field which has both an electro-static (Edc) and a time-varying ac term (Eac).

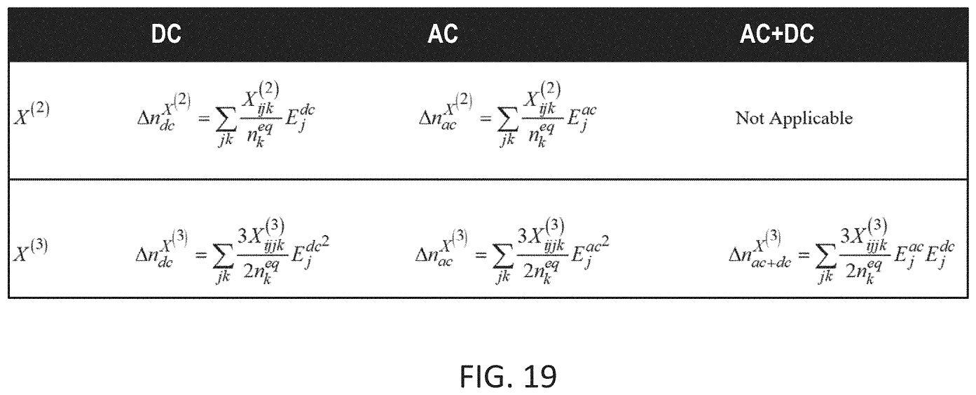

FIG. 19 shows changes of refractive index under different AC/DC conditions in accordance with one or more embodiments of the present technology. An expression is derived for each combination to the change in refractive index based on [symbol] ⁽²⁾ vs. [symbol] ⁽³⁾ and their combination of Edc and Eac fields. FIG. 19 reveals a few interesting features of such an arbitrary material. Specifically, for such a material under the presence of an Edc and Eac field there will be of course a static “bias” change in refractive index represented by Δn_{dc}=Δn_{dc} [symbol] ^{⁽²⁾}+Δn_{dc} [symbol] ^{⁽³⁾}; however, there will also be a modulated component of the change in refractive index represented by Δn_{ac}=Δn_{ac} [symbol] ^{⁽²⁾}+Δn [symbol] ^{⁽³⁾}+Δn_{ac+dc} [symbol] ^{⁽³⁾}. If a linearized modulator is to be constructed utilizing a given material's [symbol] ⁽³⁾, as well as [symbol] ⁽²⁾ if it has it, then the Δn_{ac} term is the important one to analyze. From this formula and FIG. 19, the only contributing term that is not linear in Eac is the Δn_{ac} [symbol] ^{⁽³⁾} term, which is the reason third order modulation is typically quadratically chirped, a problem for modulator design; however, the term Δn_{ac+dc} [symbol] ^{⁽³⁾} has two benefits. First, if it is required the Edc>>Eac, a condition that will dictate the degree of linearity, then the Δn_{ac+dc} [symbol] ^{⁽³⁾} term is approximately linear in Eac, and additionally under such a condition it is naturally true that Δn_{ac} [symbol] ^{⁽³⁾}<<Δn_{ac+dc} [symbol] ^{⁽³⁾} which allows one to ignore the quadratically chirped term. Secondly, the Δn_{ac+dc} [symbol] ^{⁽³⁾} term exhibits a natural form of what can be thought of as a heterodyne gain. This term has a weak high-frequency field (Eac) and a strong low-frequency field (Edc), the product of which produces an effect at the high-frequency field's frequency enhanced by the strength of the low-frequency field (Edc). While this will require the Edc field strength to be high, it will allow the Eac field strength to be proportionally lower, this can be a solution of interest as in the CMOS case as 10's of volts-dc can be acceptable whereas the AC voltage is the one that needs to be as low as possible, even sub 1V in some cases.

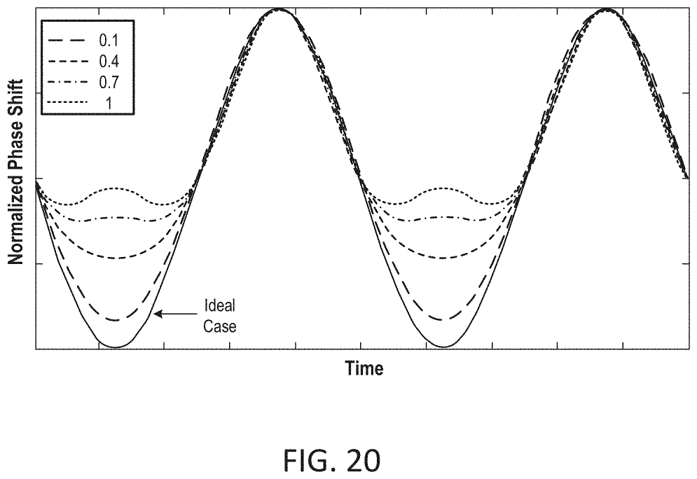

FIG. 20 illustrates modulated Eac waves as a function of the fraction of Eac/Edc for a fixed Edc in accordance with one or more embodiments of the present technology. FIG. 20 shows an example for a 10 Ghz modulated Eac wave as a function of the fraction of Eac/Edc for a fixed Edc of 1.22×10⁸V/m. In FIG. 20, the dashed line represents the idealized case. FIG. 20 shows an example of how by controlling the ratio of Eac to Edc the quadratic chirping in the resulting change in phase can be removed. Note that as the Eac/Edc ratio increases so does the peak phase change because the magnitude of Eac increases.

It is important to discuss the trade-off between [symbol] ⁽²⁾ based Pockels modulation and the [symbol] ⁽³⁾ based DC-Induced Kerr modulation. There is a general rule that the order of magnitude of [symbol] ⁽²⁾ and [symbol] ⁽³⁾ should be expected to be

$$\frac{{χ}^{( 1 )}}{{E}_{at}} \\ and \\ \frac{{χ}^{( 2 )}}{{E}_{at}}$$

respectively, where Eₐₜ is the atomic electric field strength. This has the important implication that effects based on [symbol] ⁽³⁾ are expected to be weaker than that of [symbol] ⁽²⁾ because the order of magnitude of their coefficients in general differ by the atomic electric field strength and thus an effective [symbol] ⁽²⁾ induced by the presence of an applied dc electric field could only approach that of the expected inherent [symbol] ⁽²⁾ when the applied electric field approaches that of Eₐₜ. Such a condition is of course not possible as the breakdown field of a given material will in general be much lower than Eₐₜ meaning that the maximum strength of applied electric field will be reached before the combination of [symbol] ⁽³⁾E_{applied} is expected to be of the order of the inherent [symbol] ⁽²⁾. While this may indeed be a limitation, in realistic materials, especially CMOS compatible materials, the [symbol] ⁽²⁾ tensor is often zero due to crystal symmetry, in such cases this technique can still be useful as all materials have a non-zero [symbol] ⁽³⁾ tensor. Additionally, the overall effect from [symbol] ⁽³⁾, either effective [symbol] ⁽²⁾ or the strength of the nonlinear process, while lower than that of the inherent [symbol] ⁽²⁾ can expect to be on the order of a fraction of the potential expected from the inherent [symbol] ⁽²⁾ based on the ratio of the breakdown field strength of the given material to the atomic electric field strength. For this reason, the design of a linearized modulator based on the DC-Induced Kerr effect in SRN is explored. PECVD SRN sample materials can exhibit desired high refractive indices around and greater than 3.0 and 3.1 and has a comparably enhanced [symbol] ⁽³⁾. Additionally, SRN films are expected to have a high breakdown field, as silicon nitride films can exhibit very high breakdown fields, as well as low optical loss over a broader spectral range than silicon.

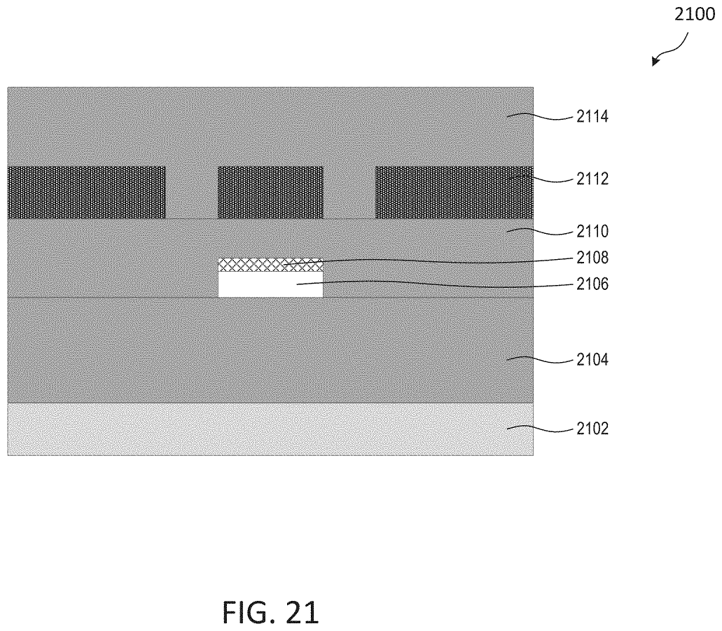

FIG. 21 illustrates an example electro-optical waveguide in accordance with one or more embodiments of the present technology. In some embodiments, electro-optical waveguide 2100 can include a substrate 2102. Substrate 2102 can include a semiconductor material, such as Si, Ge, SiGe, or GaAs. Electro-optical waveguide 2100 can include a dielectric layer 2104. Dielectric layer 2104 can be supported by substrate 2102. Dielectric layer 2104 can include a dielectric material, such as silicon dioxide (SiO₂).

Electro-optical waveguide 2100 can include a nonlinear optical material layer 2106. Nonlinear optical material layer 2106 can be formed on a top surface of dielectric layer 2104. Nonlinear optical material layer 2106 can include ZrO₂, Ta₂O₅, SRN, USRN, Si₃N₄, a-Si:H, or c-Si. Electro-optical waveguide 2100 can include a polymer layer 2108. Polymer layer 2108 can include hydrogen silsesquioxane (HSQ).

Electro-optical waveguide 2100 can include a shield layer 2110. Shield layer 2110 can enclose nonlinear optical material layer 2106 and polymer layer 2108. Shield layer 2110 can include a dielectric material, such as SiO₂.

Electro-optical waveguide 2100 can include a metal layer 2112. Metal layer 2112 can be formed on shield layer 2110. Metal layer 2112 can include a conductive metal such as Au, Ag, Cu, Al, or chromium (Cr). Electro-optical waveguide 2100 can include a cladding layer 2114. Cladding layer 2114 can enclose metal layer 2112. Cladding layer 2114 can include a dielectric material, such as SiO₂.

In some embodiments, FIG. 21 shows a schematic cross-section of a SRN waveguide device structure. In the structure a SRN waveguide is located on a SiO₂ buried oxide layer. A conformal thin dielectric shield layer (e.g., deposited using ALD) can be created. Construction of Au electrodes can be followed. Finally, the structure has a top cladding layer of SiO₂. In some embodiments, the device can lack such a shield layer. In some embodiments, the shield dielectric is SiO₂. In some embodiments, the left and right electrodes can be placed directly onto the bottom SiO₂ layer and then the center electrode can be formed after depositing a desired thickness of SiO₂. In some embodiments, the device can lack the cladding layer. The objective is to maximize the strength of the applied electric field within the waveguide core while minimizing the induced optical loss, a trade-off which will dictate the optimal device performance regime. One key parameter that will dictate the strength of the applied field is the ratio of the square of the relative permittivity of the shield layer to that of the SRN waveguide layer.

Therefore, if a thin shield layer of silicon nitride is utilized, which is known to have an RF permittivity around 7.2, to more closely match the RF permittivity of the interface to that of the SRN waveguide core which is measured to be 9.44, the penetration of the applied electric field into the waveguide can be increased. However, the trade-off is that utilizing a silicon nitride shield layer will reduce the refractive index contrast of the waveguide core, reducing mode confinement and thus increasing induced optical loss.

In general, the usage of an intermediate dielectric shield layer between the waveguide core and the metal electrodes is a necessity due to optical losses from metals. However, once introduced the mismatch in RF permittivity between the intermediate dielectric shield layer and the waveguide core will “shield” the higher RF permittivity waveguide core from the applied electric fields reducing the strength of the field within the nonlinear medium. The solution then is to utilize a material which matches the RF permittivity of the silicon-rich nitride core. However, when considering practical materials, often the RF permittivity and the refractive index increase in tandem. For example, at ˜7.2 silicon-nitride has an expected RF permittivity closer to that of SRN layer. However, it has a higher refractive index at 1.8 to 1.95 compared to the 1.45 of SiO₂ which has an RF permittivity in the range of 3.75 to 4.45. The result of this is in a realistic CMOS compatible material stack with limited choices for dielectric shield layers is a tradeoff between the strength of the applied electric field and the loss of the optical mode from the lower modal confinement of a higher refractive index shield layer. In some embodiments, SiO₂ can be used as the shield layer in order to mitigate excess loss from modal deconfinement. Since the shield layer is the same material as the cladding layer, it serves as a physical spacer rather than any additional RF permittivity matching. In some embodiments, the SRN waveguide device is based on the [symbol] ⁽²⁾ and [symbol] ⁽³⁾ values 14 pm/V and 6×10⁻¹⁹ m²/v². In some embodiments, a SRN waveguide can be 350 nm thick and 450 nm wide, and operate in TM optical mode. SRN waveguide can be along with the applied electric field lines from the ground-signal-ground (GSG) electrodes. The electrical and optical fields of the structure can be a function of both the electrode to waveguide sidewall spacing as well as the thickness of the shield layer. In some embodiments, the width and height of the waveguide can be 500 nm thick and 350 nm wide, and the waveguide can include a SiO₂ shield layer. In some embodiments, the shield layer can be the same as the cladding layer, and it serves simply as a physical spacer rather than as both a physical spacer and permittivity matching. In some embodiments, Edc>>Eac. In some embodiments, E_{dc}≅1.22×10⁸ V/m at max.

In some embodiments, a SRN waveguide sits on a SiO₂ buried oxide layer. On top of the SRN waveguide is a thin dielectric shield layer onto which Ground-Signal-Ground Au electrodes are formed. Finally, the top of the structure is top clad with SiO₂. In some embodiments, the SRN waveguide can be 350 nm thick and 450 nm wide. The SRN waveguide can be positioned along the field lines for an applied electric field.

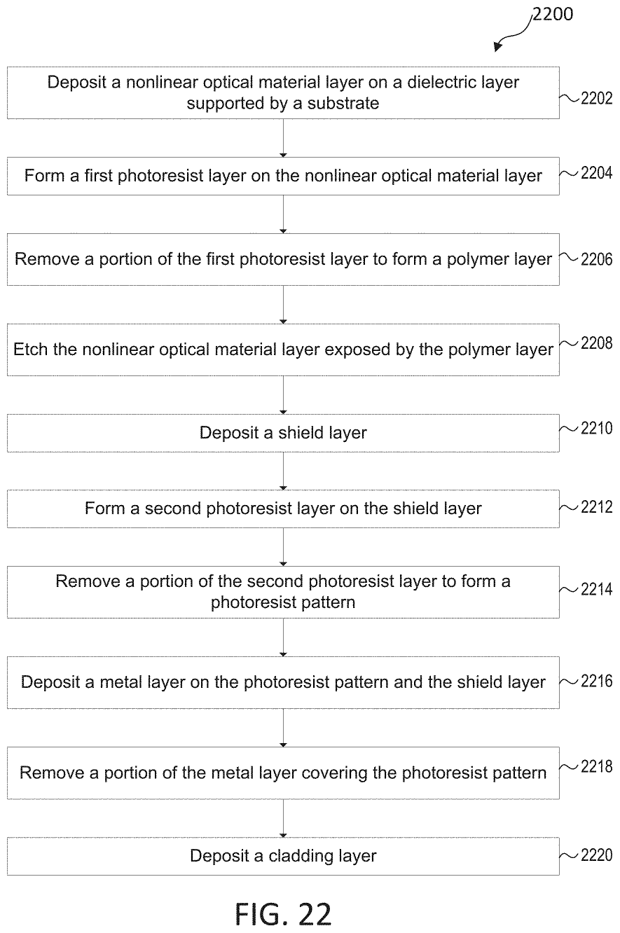

FIG. 22 is a flowchart of a method for fabricating an example electro-optical waveguide in accordance with one or more embodiments of the present technology. In some embodiments, method 2200 can be used to fabricate electro-optical waveguide 2100. In some embodiments, the operations of method 2200 may not be performed in the order shown in FIG. 22. In some embodiments, not all operations may be needed. In some embodiments, additional operations may be needed.

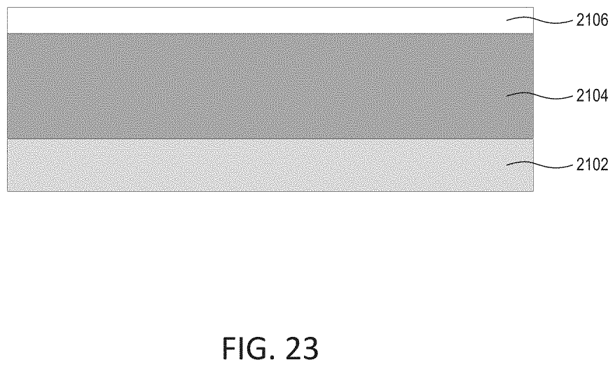

FIGS. 23-32 illustrate an example electro-optical waveguide at different fabrication stages according to the method in FIG. 22 in accordance with one or more embodiments of the present technology. The elements in FIGS. 23-32 with the same annotations with those in FIG. 21 are described with respect to FIG. 21.

At operation 2202, a nonlinear optical material layer is deposited on a dielectric layer supported by a substrate. Referring to FIG. 23, nonlinear optical material layer 2106 is deposited on dielectric layer 2104 supported by substrate 2102. In some embodiments, nonlinear optical material layer 2106 can be deposited by PECVD.

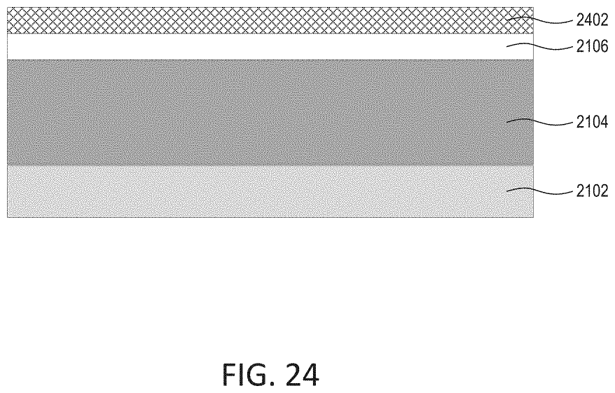

At operation 2204, a first photoresist layer is formed on the nonlinear optical material layer. Referring to FIG. 24, a first photoresist layer 2402 is formed on nonlinear optical material layer 2106. In some embodiments, first photoresist layer 2402 can be formed by spin coating.

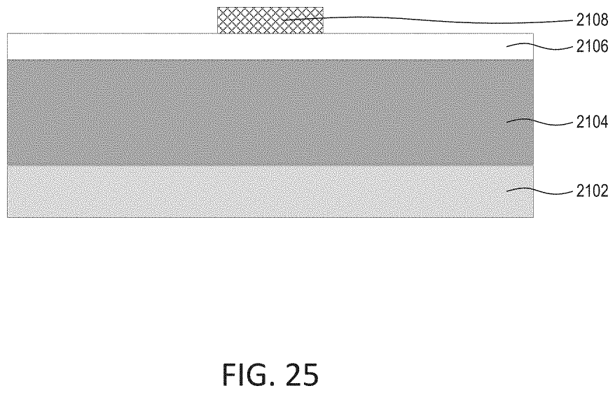

At operation 2206, a portion of the first photoresist layer is removed to form a polymer layer. Referring to FIG. 25, a portion of first photoresist layer 2402 is removed to form polymer layer 2108. In some embodiments, the portion of first photoresist layer 2402 can be removed by E-beam lithography.

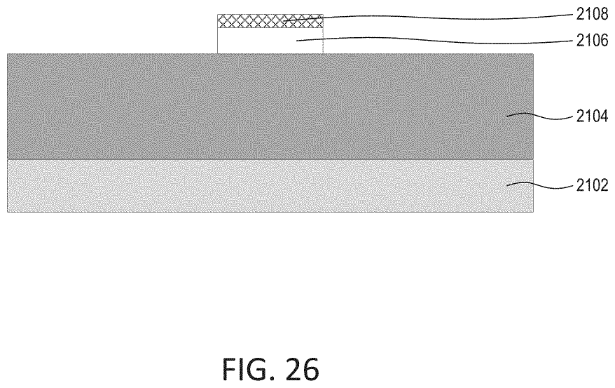

At operation 2208, the nonlinear optical material layer exposed by the polymer layer is etched. Referring to FIG. 26, nonlinear optical material layer 2106 exposed by polymer layer 2108 is etched. In some embodiments, nonlinear optical material layer 2106 exposed by polymer layer 2108 can be etched by dry etching. Some thickness of polymer layer 2108 is also etched.

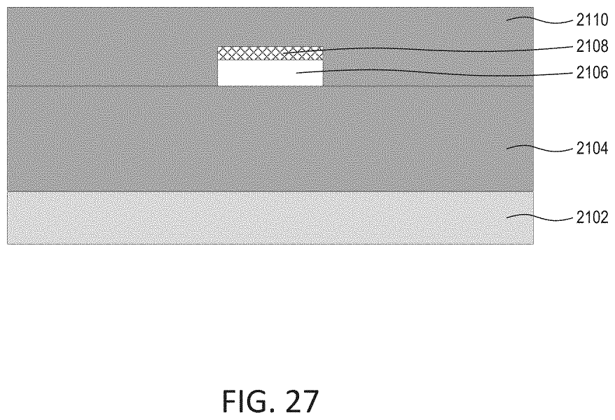

At operation 2210, a shield layer is deposited. Referring to FIG. 27, shield layer 2110 is deposited. In some embodiments, shield layer 2110 can be deposited by atomic layer deposition (ALD), CVD, or PECVD.

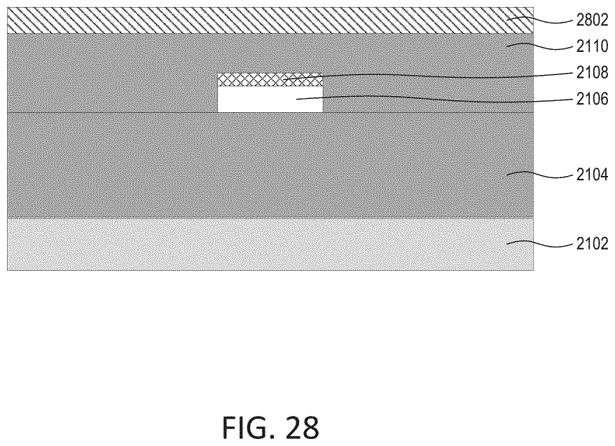

At operation 2212, a second photoresist layer is formed on the shield layer. Referring to FIG. 28, a second photoresist layer 2802 is formed on shield layer 2110. Second photoresist layer 2802 can be a SF6/AZ1512 bilayer. In some embodiments, second photoresist layer 2802 can be formed by spin coating.

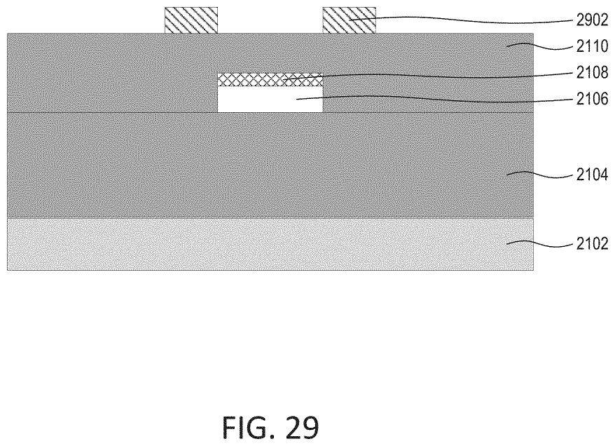

At operation 2214, a portion of the second photoresist layer is removed to form a photoresist pattern. Referring to FIG. 29, a portion of second photoresist layer 2802 is removed to form a photoresist pattern 2902. In some embodiments, a portion of second photoresist layer 2802 can be removed by photolithography, E-beam lithography, or micro laser annealing (MLA).

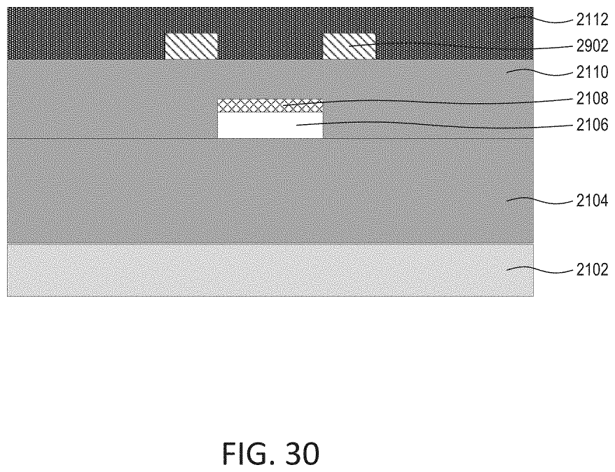

At operation 2216, a metal layer is deposited on the photoresist pattern and the shield layer. Referring to FIG. 30, metal layer 2112 is deposited on photoresist pattern 2902 and shield layer 2110. In some embodiments, metal layer 2112 can be deposited by sputtering.

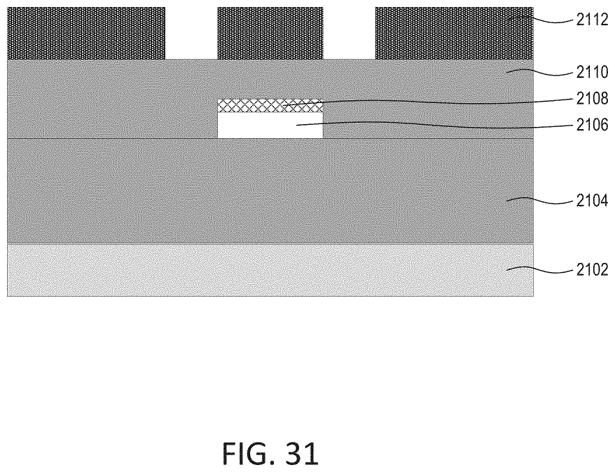

At operation 2218, a portion of the metal layer covering the photoresist pattern is removed. Referring to FIG. 31, a portion of metal layer 2112 covering photoresist pattern 2902 is removed. In some embodiments, the portion of metal layer 2112 covering photoresist pattern 2902 can be removed by a lift-off process to remove photoresist pattern 2902.

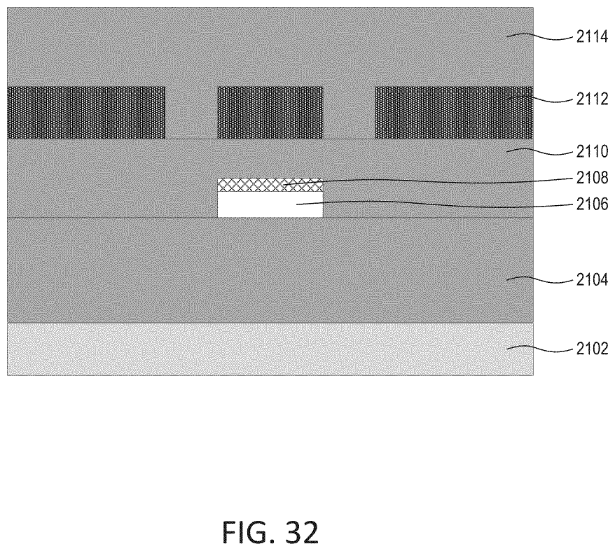

At operation 2220, a cladding layer is deposited on the metal layer. Referring to FIG. 32, cladding layer 2114 is deposited on metal layer 2112. In some embodiments, cladding layer 2114 can be deposited by CVD, ALD, or PECVD.

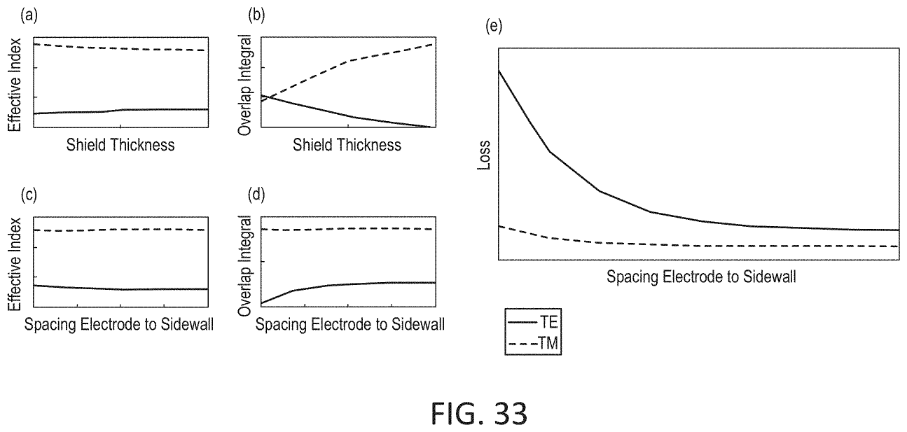

FIG. 33 illustrates modulator parameters as a function of physical characteristics in accordance with one or more embodiments of the present technology. Result (a) shows effective index of the TE-like and TM-like modes vs SiO₂ shield thickness. Result (b) shows overlap integral of the TE-like and TM-like modes with the SRN waveguide core versus SiO₂ shield thickness. Result (c) shows effective index of the TE-like and TM-like modes vs spacing from the electrode to waveguide sidewall. Result (d) shows overlap integral of the TE-like and TM-like modes with the SRN waveguide core versus spacing from the electrode to waveguide sidewall. Result (e) shows propagation loss vs electrode to sidewall spacing for the TE-like and TM-like modes. Results (a-b) show the effective index and overlap integral of the TE-like and TM-like modes as a function of shield thickness. In the case where the shield layer is simply the same as the cladding layer, the shield layer simply serves as a physical spacer predominately for the central electrode. As a result, at small shield thickness the TM-like optical mode gets pulled into the thin gap between the center electrode and the waveguide core, increasing the effective index but decreasing the overlap with the SRN layer. Results (c-d) show that a similar effect occurs for the TE-like mode when the electrodes are brought closer to the sidewall of the waveguide with the enhancement of the effective index and corresponding decrease in overlap integral. The same effect is smaller for the TM-like mode due to large gaps than the shield layer thickness. The tradeoff of course is loss, which is shown in result (e). When the electrode to sidewall spacing is reduced, the loss increases. Naturally, the TE-like mode sees a faster increase in loss from bringing the electrodes closer to the sidewall, whereas the TM-like mode will see a faster increase as the shield thickness decreases. It is important to remember the tensorial nature of [symbol] ⁽²⁾ and [symbol] ⁽³⁾ in light of these facts, specifically the different tensor components utilized depending on the orientation of the optical polarization and applied electric field. The fundamental relation between second and third order nonlinearities, and the presences of a non-zero [symbol] ⁽²⁾ in SRN, means that all else being equal a TM polarized optical mode and vertical applied field will produce the largest change in refractive index as it will utilize both the largest [symbol] ⁽²⁾ and [symbol] ⁽³⁾ tensor.

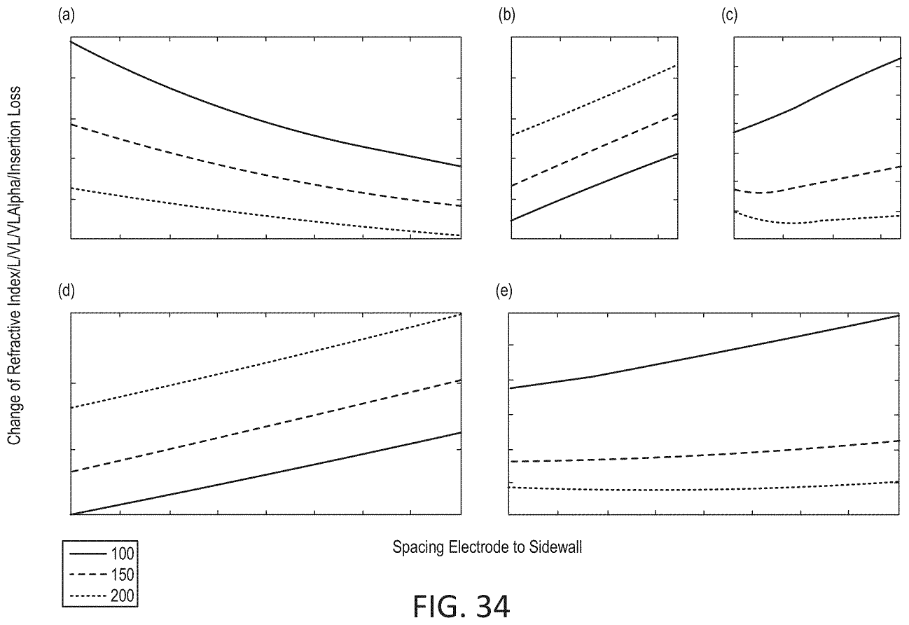

FIG. 34 illustrates more modulator parameters as a function of physical characteristics in accordance with one or more embodiments of the present technology. Result (a) shows a plot of the change in refractive index under the presence of a combination of AC and DC field. In such a situation if Edc>>Eac then approximately Δn_{ac}=Δn_{ac} [symbol] ^{⁽²⁾}+Δn_{ac+dc} [symbol] ^{⁽³⁾}. Result (b) shows a plot of the require length for a π phase shift based on Δn_{ac} as a function of electrode to sidewall spacing and shield thickness. Result (c) shows a plot of lumped loss for a phase shifter with a length of L_{π} as a function of electrode to sidewall spacing and shield thickness. Result (d) shows the metric V_{π}L_{π} determined from the change in refractive index. Result (e) shows while the metric V_{π}L_{π} is a commonly used metric for such devices, a more comprehensive metric is V_{π}L_{π}α which includes loss and is thus in units of V-dB instead of V-cm. The Δn_{ac} with respect to the applied electric field is shown in result (a), for electrode to sidewall spacings from 200 nm to 600 nm and shield thickness from 100 nm to 200 nm. The trade-off here is clear. At a fixed voltage, smaller electrode to sidewall spacings result in larger applied field strengths at a fixed voltage, and thus larger changes in refractive index. Similarly, decreasing the shield layer thickness increases the applied field strength in the waveguide core at a fixed voltage and thus increases the change in refractive index. From the change in refractive index curves the minimum length required for a π phase shift (L_{π}) is determined as a function of electrode to sidewall spacing and shield thickness, which is shown in result (b). As the shield thickness increases the strength of the applied electric field in the waveguide core reduces thus requiring longer path lengths to maintain a π phase shift. Using the lengths from result (b) and the propagation loss values discussed in FIG. 33, the insertion loss is shown in result (c) reaching values as low as 5.8 dB. Result (d) then shows the V_{π}L_{π} for each corresponding case under the condition that

$$\frac{{E}_{dc}}{{E}_{ac}} ≅ 10.$$

From this it is clear that competitive V_{π}L_{π} metrics can be achieved from 2 to 3.5 Vcm. However, this is only a part of the story as a comprehensive figure of merit should include the loss. An additional figure of merit is defined to be V_{π}L_{π}α which results in a unit of V-dB. Result (e) shows such a figure of merit including the loss in the analysis. The way to interpret such a figure of merit is to consider that at a V_{π}L_{π}α of 37 VdB at 20 Vpp AC voltage would have an insertion loss of 1.85 dB. It is through a combination of these two figures of merit that the design space, and tradeoffs between voltage, length, and insertion loss can be understood.

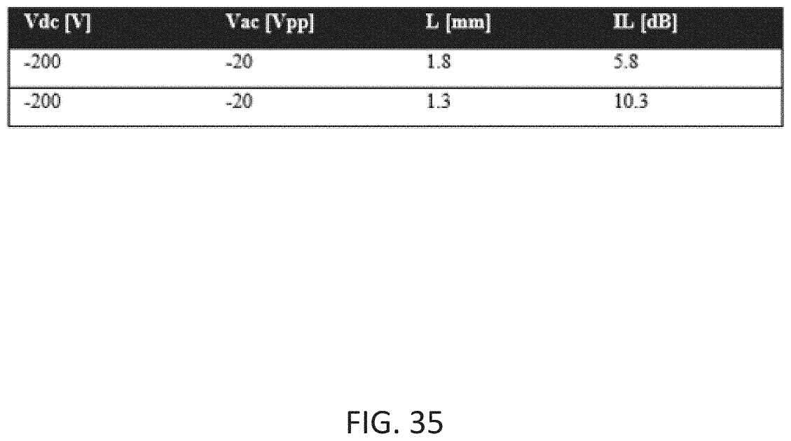

FIG. 35 illustrates modulator performances in accordance with one or more embodiments of the present technology. Modulator performances can be based on results shown in FIGS. 33 and 34. In some embodiments, modulators can be SRN modulators. FIG. 35 shows performances for some example modulators. A clear trend is a tradeoff between voltage and lumped loss. A V_{π}L_{π} of 2 Vcm with a 6.2 Vpp AC voltage can be achieved at an insertion loss of 10 dB. A V_{π}L_{π} of 2 Vcm with a 20 Vpp AC voltage can be achieved at an insertion loss of 3.1 dB.

In some embodiments, a phase modulator can be used as an intensity modulator by embedding it into a ring resonator cavity or in a Mach Zehnder interferometer (MZI) configuration. Both ring-resonator and Mach Zehnder configurations have their own advantages and drawbacks, but they can be thought of as broadly representing the two categories of intensity modulators, resonant and non-resonant respectively. A ring resonator can be viewed as a form of a resonant filter, which when the resonant condition, ϕ_{roundtrip}=m2π, is satisfied light is lost from the transmission port while off resonant light is allowed to pass. It is this condition that allows a phase modulator embedded into the cavity of a ring resonator to be realized as an intensity modulator. The phase introduced by the phase modulator adds to the nominal roundtrip phase and changes the wavelength at which the nominal round trip phase plus the phase change from the modulator results in an integer multiple of 2π.

$${T}_{p} = \frac{{a}^{2} - 2 ra cos ( ϕ ) + {r}^{2}}{1 - 2 ra cos ( ϕ ) + {( ra )}^{2}} \qquad ( 3 )$$

Equation 3 shows the expression for the transmission from an all-pass configuration ring-resonator where r is the self-coupling coefficient of the bus, k is the cross-coupling coefficient, a is the single-pass amplitude transmission, and p is the single-pass phase shift. Therefore, in the idealized case the critical coupling condition can be shown to be when the coupled power is equal to the power lost in the ring, or r=a.

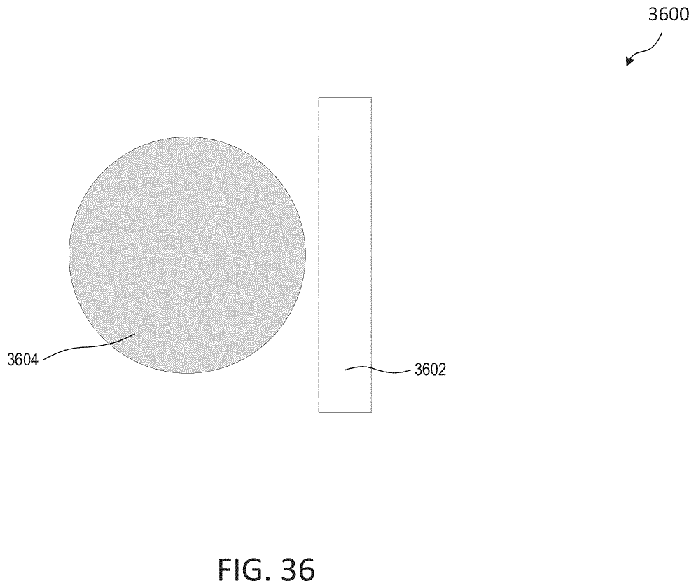

FIG. 36 illustrates an example ring resonator in accordance with one or more embodiments of the present technology. Ring resonator 3600 can include a ring resonator cavity 3604 and a phase-shift element 3602. In some embodiments, a phase-shift element can be embedded into the cavity of a SRN 45 μm bend radius ring resonator. In some embodiments, there can be an ‘unintended’ mismatch between the amplitude transmission coefficient and the self-coupling coefficient of 0.05. In some embodiments, the phase modulator includes 90% of the cavity length, to accommodate the coupling region.

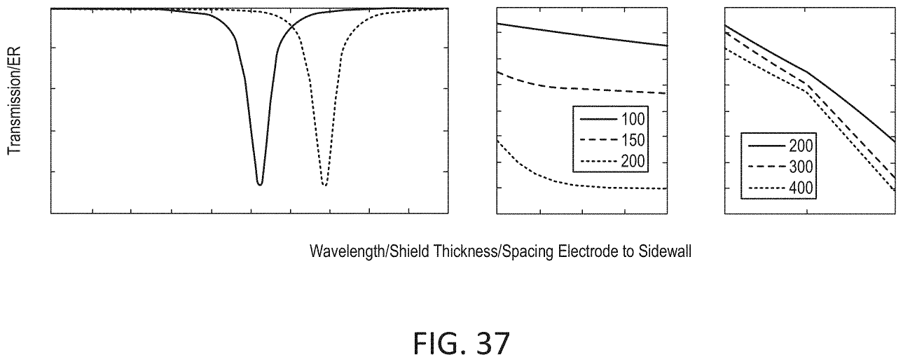

FIG. 37 illustrates transmission spectra as a function of modulator physical characteristics in accordance with one or more embodiments of the present technology. Result (a) shows transmission spectra and maximum shift in transmission spectra for a 45 μm bend radius ring modulator with a Δᵣ₋ₐ=0.05 mismatch between the single pass amplitude transmission coefficient and the self-coupling coefficient of the bus. Result (b) shows extinction ratio as a function of electrode to sidewall spacing for shield thickness 100 nm to 200 nm. Result (c) shows extinction ratio as a function of shield thickness for electrode-sidewall spacings from 200 nm to 600 nm. In some embodiments, result (a) shows the transmission spectra of the nominal device T(ϕ) in black along the shifted transmission spectra T(ϕ+Δϕₘₐₓ) due to Δn_{ac}. Results (b) and (c) then show the extinction ratio (ER), here defined as the ratio of transmission from the nominal spectra and the transmission under the peak phase change, as a function of electrode to sidewall spacing and shield thickness. Two general trends can be seen in results (b) and (c). First, increasing electrode to sidewall spacing decreases the ER. Second, increasing shield thickness decreases the ER. As long as the ring resonator is in the critical coupling regime, increasing either the electrode to sidewall spacing or the shield thickness reduces the ER by decreasing the strength of the applied field within the waveguide core. On the other hand, reducing the electrode to sidewall spacing or the shield thickness increases the loss. In the case of a ring resonator, this impacts the maximum achievable quality factor. A commonly used definition of the quality factor is the ratio of stored energy in the cavity to energy dissipated per cycle and therefore is a measurement of the rate of decay of energy in the cavity.

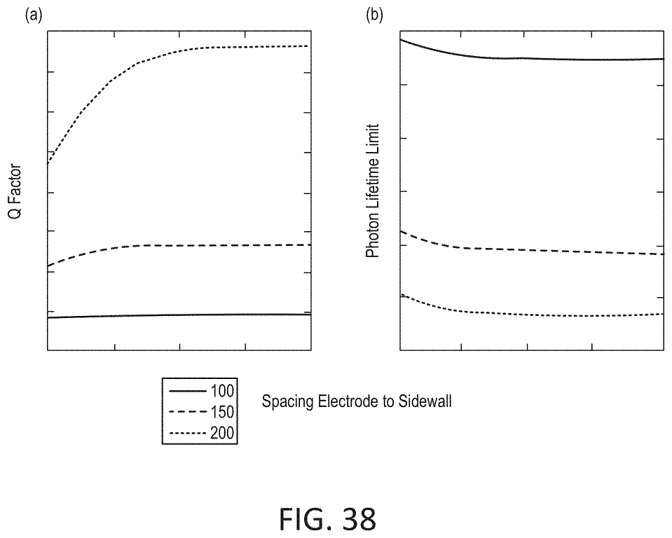

FIG. 38 illustrates tradeoffs as a function of modulator physical characteristics in accordance with one or more embodiments of the present technology. Quality factor and photo lifetime limit are the two tradeoffs shown in FIG. 38. Result (a) shows quality factor versus electrode to sidewall spacing for shield thickness 100 nm to 200 nm. Result (b) shows photon lifetime limited bandwidth vs electrode to sidewall spacing for shield thickness 100 nm to 200 nm. Result (a) shows the quality factor of a ring resonator with a Δᵣ₋ₐ mismatch of 0.05 vs electrode to sidewall spacings for shield thickness from 100 nm to 200 nm. The reduction in quality factor for increasing loss (decreased electrode to sidewall spacing or decreased shield thickness) can clearly be seen. As ring resonators are resonant cavities, the enhanced intensity contrast is a tradeoff with the ring-down time of the cavity which limits response times. Using the quality factor vs electrode to sidewall spacing and shield thickness, the photon-lifetime limited bandwidth is

$$\frac{1}{2 {πτ}_{cavity}} ,$$

where τ_{cavity} is the photon lifetime of the cavity and related to the quality factor as

$$Q = \frac{{ω}_{0} {τ}_{cavity}}{2} .$$

Result (b) snows that increasing quality factors results in lower photon lifetime limited bandwidths, reaching as low as ˜10 Ghz for the largest quality factors. Additionally, there is a slight enhancement in photon lifetime limited bandwidth at the smallest electrode to side wall spacings. Based on these results a photon lifetime limit of 60 Ghz requires a quality factor of 2000, which is naturally achieved at a shield thickness of 100 nm. Therefore, integrating the phase modulator into a ring resonator cavity will allow ERs of 10 dB to 18 dB and photon lifetime bandwidths of 60 Ghz for Q factors of 2000. The non-resonant alternative is the Mach Zehnder Interferometer configuration. Unlike the ring resonator, the MZI configuration being non-resonant does not have a photon lifetime limit to its bandwidth. It is instead limited by the capacitive load of the electrodes.

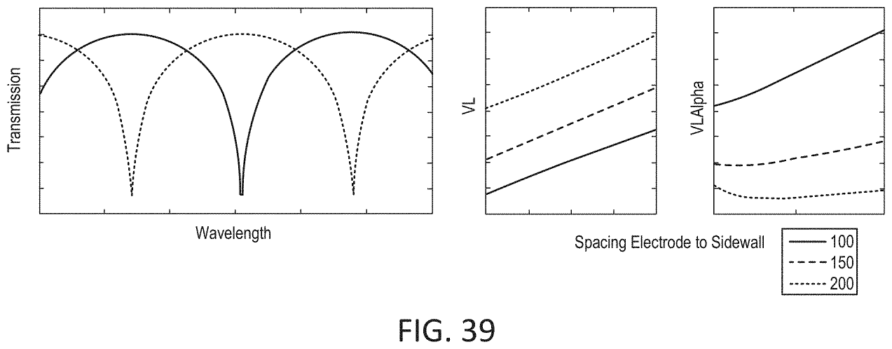

FIG. 39 illustrates Mach Zehnder Interferometer parameters as a function of physical characteristics in accordance with one or more embodiments of the present technology. In some embodiments, an unbalanced MZI, with a mismatch length of 200 μm, and the phase modulator of length L_{π} in both arms are considered. Result (a) shows the spectral response of such an unbalanced MZI in the nominal case T(ϕ). Result (a) shows transmission spectra and maximum shift in transmission spectra for a MZI with an imbalance length of 200 μm along with electrodes of the L_{π} length in both arms driven in push-pull. Result (b) shows a plot of the V_{π}L_{π} metric versus electrode to sidewall spacing and shield thickness. Result (c) shows a plot of the V_{π}L_{π}α metric versus electrode to sidewall spacing and shield thickness. In the case of the MZI, by controlling the relative phases introduced into both arms, an intensity modulator can be formed. For the intensity modulator, the push-pull configuration is considered where the electrical driving signal of the two arms is π out of phase with each other. The resulting V_{π}L_{π} and V_{π}L_{π}α metrics can be seen in results (b) and (c) respectively. The analysis here is a fairly straightforward extension of the phase modulator. Result (a) shows a full π phase shift in the spectra is achievable. The corresponding figures of merit clarify that in addition to converting the phase modulator into an intensity modulator, the V_{π}L_{π} is cut in half, achieving values as low as 0.5 Vcm as a result of utilizing push pull. The primary trade-off in this design is one of compactness. Unlike the ring resonator configuration which can be made as small as twice the bend radius of choice, the MZI here requires electrode lengths of L_{π} which is 1 mm or longer. The trade-off here then is that the V_{π}L_{π} metric is cut down as low as 0.5 Vcm in the push-pull MZI. However, the longer electrodes relative to the ring resonator as well as being driven in push-pull, which is likely to lead to a parallel set of capacitances, relative to the phase modulator means that it will have the largest capacitance of the three configurations. SRN Mach Zehnder can achieve a V_{π}L_{π} between 0.5 to 1 Vcm while lithium niobate on insulator devices achieves values in the range of 1.8 Vcm. However, compared to only CMOS compatible techniques such as a depletion type silicon modulator, the values are in the range of 3.5 Vcm.

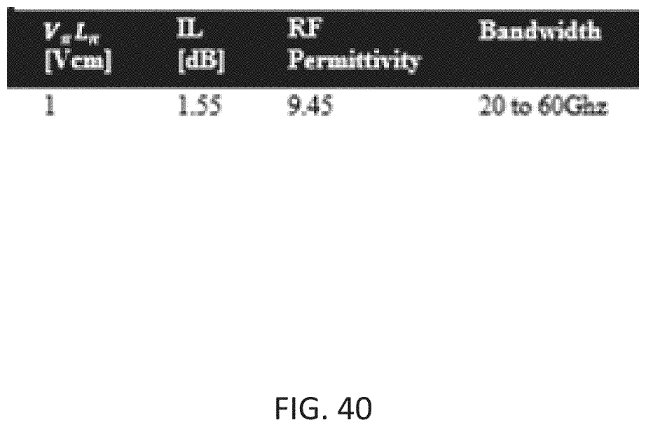

FIG. 40 illustrates Mach Zehnder Interferometer performances in accordance with one or more embodiments of the present technology.

Other techniques range from lithium niobate on insulator to hybrid silicon on barium titanate (BTO) thin-film approaches. Of these various approaches the silicon on BTO thin-film achieves the clear best V_{π}L_{π} metric; however, being a silicon on BTO thin-film device requires post-processing and is not in general CMOS compatible. Additionally, the large nonlinearities that allow for low voltages are in general smaller when used for wave-mixing. This patent document disclose techniques that can be clearly defined as CMOS compatible material stacks. SRN DC-Induced Kerr modulators can achieve competitive V_{π}L_{π} metrics and being a low temperature PECVD process it can bring new capabilities to CMOS compatible platforms.

Traditionally electro-optic modulators have relied upon second order nonlinearities, utilizing the Pockels effect; however, materials that exhibit non-zero [symbol] ⁽²⁾ tensors are generally not CMOS compatible. Meanwhile [symbol] ⁽³⁾ based modulation has typically been seen as un-attractive due to a much weaker nonlinearity exhibited by most materials as well as the quadratic nature of the effect. In this patent document, a systematic evaluation of electro-optic nonlinearities in a generic material is disclosed. The unique combination of [symbol] ⁽²⁾ and [symbol] ⁽³⁾ exhibited by SRN makes it a good candidate for capacitive [symbol] ⁽³⁾ based electro-optic modulation. SRN can achieve V_{π}L_{π} metrics as low as 1 Vcm in a MZI configuration and extinction ratios as high as 18 dB in a ring resonator configuration all utilizing a CMOS compatible material platform. Additionally, the traditional drawback of quadratic chirping in [symbol] ⁽³⁾ based modulators are overcome by showing that proper choice of the Eac/Edc ratio can not only linearize the change in phase but can also be seen as a heterodyne gain approach with the mixing of the weak high frequency Eac term and the strong low frequency Edc term. While for some applications utilizing a non-CMOS device such as a lithium niobate on insulator modulator can be acceptable, there is a need for CMOS compatible alternatives to such devices. As it stands now if a designer is limited to CMOS processing due to a desire to utilize cost effective tapeouts then they are primarily limited to carrier dispersion-based modulators in silicon. In this patent document, adoption of [symbol] ⁽³⁾ based modulator can provide additional utility to such CMOS platforms and that SRN is a good candidate for such adoption. PECVD based silicon nitride films are already widely utilized in CMOS tapeouts. With proper tuning of gas flow ratios, a high refractive index PECVD SRN film (e.g., around or higher than 3.0 and 3.1) can be achieved under otherwise the same processing conditions. In this patent document, the unique advantages of high confinement guiding in a low RF permittivity high [symbol] ⁽³⁾ and low loss in such a platform make it an attractive candidate for integration into standard CMOS process flows. Linearized [symbol] ⁽³⁾ based modulators can be used in a variety of material platforms and can provide new and unique capabilities.

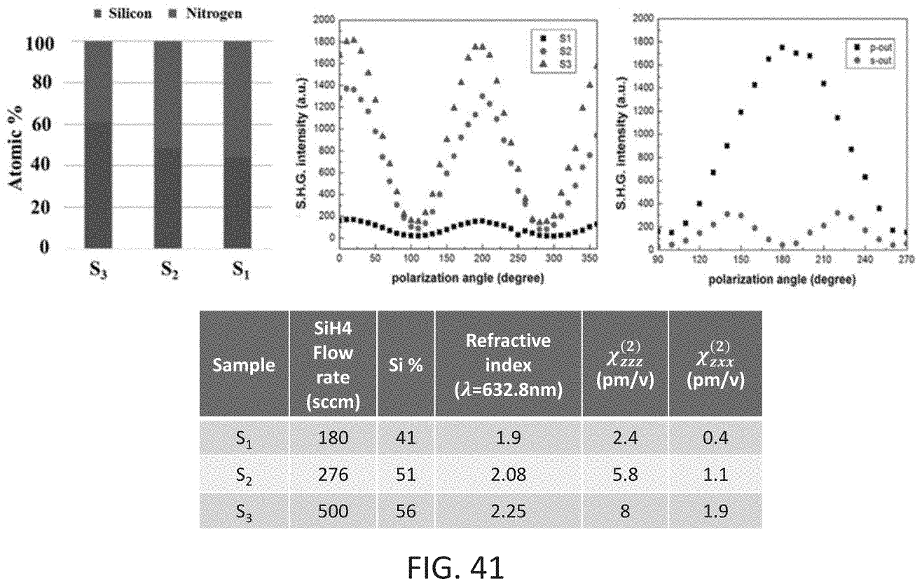

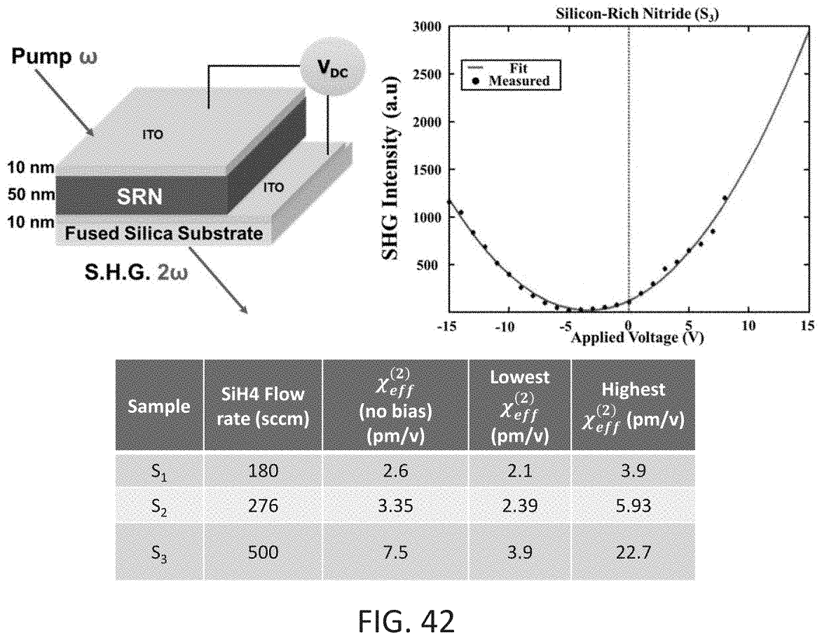

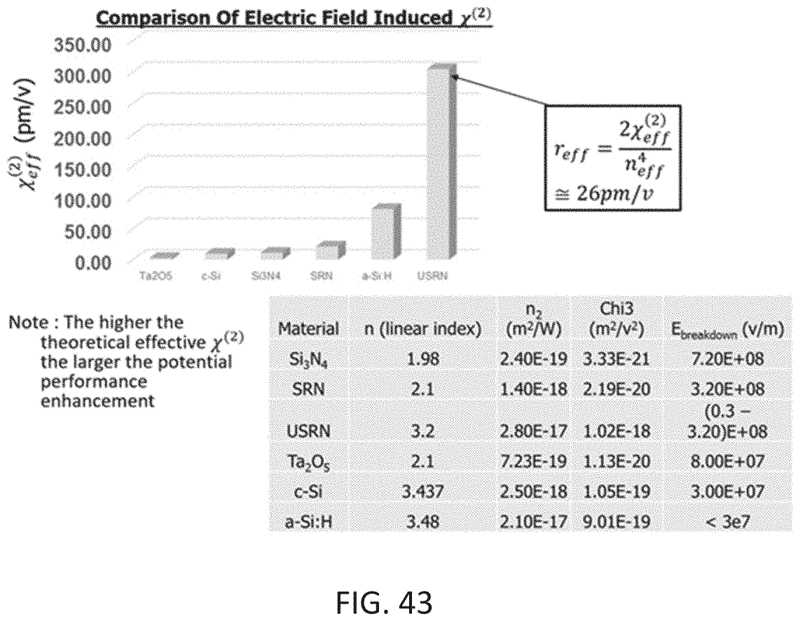

FIGS. 41-43 illustrate material properties that can be used in an example electro-optical modulator in accordance with one or more embodiments of the present technology. Some information for SRN materials as shown in FIGS. 41-43 are suitable for implementing the VCSEP devices. One type of nonlinear optical materials suitable for implementing the above VCSEP devices is PECVD SRN materials exhibiting a significant DC-Kerr effect to cause optical phase shifts for beam steering and other optical applications. This patent document discloses that the DC-Kerr effect in PECVD SRN exhibits a third order nonlinear susceptibility as high as (6+/−0.58)×10⁻¹⁹ m²/V², which is larger than that of silicon. Such PECVD SRN materials can be used to provide a versatile platform for employing optical phase shifters while maintaining a low thermal budget using a deposition technique readily available in CMOS process flows.

The DC-Kerr effect in PECVD SRN demonstrates a third order nonlinear susceptibility, [symbol] ⁽³⁾, as high as (6±0.58)×10⁻¹⁹ m²/V². Spectral shift versus applied voltage measurements in a racetrack resonator can be used to characterize the nonlinear susceptibilities of these films. This patent document discloses a [symbol] ⁽³⁾ larger than that of silicon and PECVD SRN can provide a versatile platform for employing optical phase-shifters while maintaining a low thermal budget using a deposition technique readily available in CMOS process flows.

The search for ever more efficient devices to power the next generation of optical interconnects has long been a driving force behind research in nonlinear optics. Lithium niobate on insulator platform as well as high-k ferroelectric perovskites such as barium titanate (BaTiO₃) are explored in order to realize more efficient electro-optic switches. However, the low refractive index relative to silicon, and high RF permittivity remain a challenge for these platforms. Furthermore, the strong push towards CMOS compatible fabrication has continued to drive interest in CMOS compatible alternatives for realizing electro-optic switches. The natural choice would be to use a material (or its variant) and an effect that is already available as part of the current silicon photonics platform, such as the plasma dispersion or the DC-Kerr effect. Plasma dispersion-based switching is a commonly utilized technique in the Silicon-On-Insulator (SOI) platform; however, for many applications an ultra-low energy per bit metric is required, making all-phase modulation desirable.

An alternative to directly utilizing silicon is to engineer optical nonlinearities in existing CMOS compatible materials. An attractive candidate for this is non-stoichiometric silicon nitride, and in particular SRN. A variety of deposition techniques, including but not limited to Inductively Coupled Plasma Chemical Vapor Deposition (ICP-CVD), PECVD, and

Low-Pressure Chemical Vapor Deposition (LPCVD) can be used to demonstrate low loss SRN film with enhanced second and third order nonlinear susceptibilities ( [symbol] ⁽²⁾ and [symbol] ⁽³⁾). Using these deposition techniques, SRN films can demonstrate efficient four-wave mixing, where in the case of ultra-silicon-rich nitride [symbol] ⁽³⁾ coefficients as high as 1.02×10⁻¹⁸ m²/V² can be obtained. In silicon, DC-Kerr based modulation can be demonstrated using a [symbol] ⁽³⁾ of 2.45×10⁻¹⁹ m²/V². Ultra-silicon rich nitride has a variety of highly desirable characteristics for electro-optic switching better than silicon. This patent document discloses the exploration of the DC-Kerr effect in this platform.

In this patent document, it is shown that SRN possess several advantages which make it a strong candidate for practical switching applications. Specifically, a PECVD grown SRN film with a refractive index of 3.02 at 1500 nm can experimentally demonstrate a [symbol] ⁽³⁾ as high as (6±0.58)×10⁻¹⁹ m²/V². Additionally, PECVD based deposition of SRN is a technique readily available in CMOS process flows for realizing highly nonlinear SRN films for electro-optic switching applications.

Plasma-dispersion based switching is commonly utilized for switching applications in silicon; however, this technique produces, an often un-desirable, change in the imaginary part of the refractive index as well as the real part. An alternative to plasma dispersion is to utilize the Pockels effect, such as is exploited by Lithium Niobate modulators. However, due to central crystal symmetry silicon does not possess a [symbol] ⁽²⁾. As an alternative to this, the DC-Kerr effect can be demonstrated in silicon utilizing a p-i-n junction configuration. This can be an effective method for realizing electro-optic modulation in silicon. However, its realization has currently been limited to p-i-n junction configurations as a means of overcoming the challenges of engineering efficient overlap of the electric field with the optical mode within a semiconductor. The i-th component of the refractive index modulation, Δnᵢ due to DC induced Kerr effect is given by:

$${Δ n}_{i} = \frac{3 {Γ}_{SRN}}{2} {\sum }_{i , j} \frac{{X}_{ijkl}^{( 3 )}}{{n}_{i , eq}} {E}_{j}^{{dc}^{2}} {E}_{k}^{dc} , \qquad ( 4 )$$

where Γ_{SRN}, n_{l,ea}, [symbol] ᵢⱼₖₗ⁽³⁾, and Eₖ^{dc} represent the overlap factor, the unperturbed material index of the “lth” polarization, “ijkl” tensor component of the [symbol] ⁽³⁾, the jth and kth component of the applied electric field, respectively. The utilization of electrodes in a top-down configuration, with a grounded substrate, results in an applied electric field (Eⱼ^{dc}) which is predominately aligned normal to the thin SRN film which along with isotropic material symmetry allows equation 4 to be reduced to equation 5:

$${Δ n}_{i} = \frac{3 {Γ}_{SRN}}{2} {\sum }_{i , j} \frac{{X}_{ijkl}^{( 3 )}}{{n}_{i , eq}} {E}_{j}^{{dc}^{2}} \qquad ( 5 )$$

It should further be noted that for SRN's material class only certain tensor components will be non-zero. For a TM-polarized optical mode, the only participating non-zero tensor component is the [symbol] ₃₃₃₃⁽³⁾. It is evident that with this approach electro-optic switching in any material platform can be achieved regardless of its crystal symmetry, as long as the given material has a large enough combination of [symbol] ⁽³⁾ and high electric breakdown field strength. However, in SRN the overall change in the material index is often a combination of both second and third order contributions, due to the Pockels and DC-Kerr effects respectively, even if the second order contributions are often small. As such an accurate estimate of the [symbol] ⁽³⁾ requires consideration for the contributions of both these terms due to the presence of a non-zero [symbol] ⁽²⁾. For these reasons, SRN is a very attractive candidate. Specifically, SRN thin films can exhibit very high third order nonlinear susceptibilities, even larger than that of silicon itself. SRN thin films can have a higher breakdown field, while remaining a low loss dielectric waveguiding material. It is for this reason that SRN is a strong candidate platform for electro-optic switching. The nonlinear optical response of these films enables them to be used as a wave guiding material.

In some embodiments, a bus-coupled racetrack ring resonator and a TM-polarized optical mode can be used to carry out electro-optic characterization of the all-normal components of the SRN film's susceptibility tensors. Au-SRN-Au capacitors can be used to confirm the safe operating range of electric fields for these films. These measurements confirm that SRN films can be safe for application of fields up to 1.2×10⁸V/m. Approximate RF permittivity of the SRN films is 9.0578. Ellipsometric measurements performed at a wavelength of 800 nm confirm the SRN films to increase in refractive index when they undergo rapid thermal annealing (RTA) at 300° C. Furthermore, ellipsometry results confirm the refractive index of the SRN films to be 3.01896 at 1500 nm. In some embodiments, the device architecture uses a 320 nm thick PECVD SRN device layer on top of a 3 μm wet thermal oxide on a silicon handling wafer. The device can include a point-coupled racetrack ring resonator with a bend radius of 45 μm and straight arm sections of 250 μm. All such resonators have a waveguide width of 450 nm and coupling gaps ranging from 100 nm to 400 nm. The device geometry can be written by electron beam lithography in a 400 nm thick fox-16 soft mask followed by dry etching using reactive ion etching in an Oxford P100 etcher. After etching, the remaining fox-16 is removed using 1:10 Buffered Oxide Etchant diluted in D.I. water. The devices are then cladded with a 1 μm thick layer of PECVD SiO₂. Electrode traces 30 μm wide with a 10 μm separation are then patterned on top of the top clad using an AZ1512/SF9 bi-layer soft mask and DC sputtering of gold in a Denton 635 sputtering system. These devices then undergo RTA at 300° C. in a forming gas ambient for 15 mins. The devices are then diced to expose the edge facets of the waveguides.

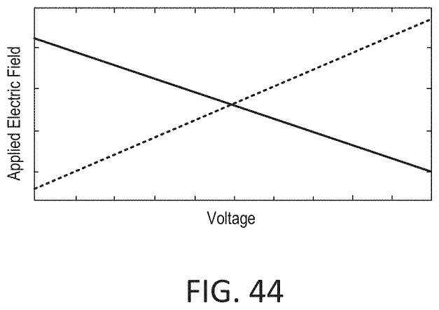

FIG. 44 illustrates applied electric fields in accordance with one or more embodiments of the present technology. The electrode design needs to ensure a uniform and directional distribution of the applied DC electric field. FIG. 44 shows the mean value of the applied field Eₓ and E_{z} components versus voltage inside the waveguide core. By using a wide central trace along with grounding the device substrate, the applied field distribution can be made to have as much as a 3 order of magnitude difference between the in-plane and out-of-plane applied fields. This allows electro-optic measurements to attribute the TM-like polarized optical mode to the [symbol] ₃₃₃₃⁽³⁾ tensor component.

For characterization, a fiber coupled input, free-space output setup with a tunable Agilent 8164B CW source which has a wavelength span of 1465 nm to 1575 nm can be used. Electrical probes are used to contact the electrical pads applying voltage from a Keithly Source Meter 2400 with a maximum voltage range of +210 V.

To characterize the DC-Kerr effect, transmission spectra measurements are taken as a function of applied voltage. Using these spectral measurements, the shift in resonant wavelength versus voltage can be extracted. This measurement of resonant wavelength shift (Δλᵣₑₛ) versus voltage can then be related to the change in effective index (Δn_{eff}) on a first order approximation using equation (6):

$$\frac{{Δ n}_{eff}}{{n}_{g}} \frac{{L}_{mod}}{{L}_{total}} = \frac{{Δ λ}_{res}}{{λ}_{res}} \qquad ( 6 )$$

Equation 6 is a ratio of the group index (n_{g}) and the resonant wavelength (λᵣₑₛ) scaled by the modulated length of the ring (L_{mod}) as a fraction of total length of the ring (Lₜₒₜₐₗ), 440 μm and 782.74 μm respectively. Using electrodes in a top-down configuration ensures an all-vertical applied field. Thus, when these measurements are carried out for a TM-like optical mode, the measurements are attributed entirely to the all normal type [symbol] ₃₃₃⁽²⁾ and [symbol] ₃₃₃₃⁽³⁾.

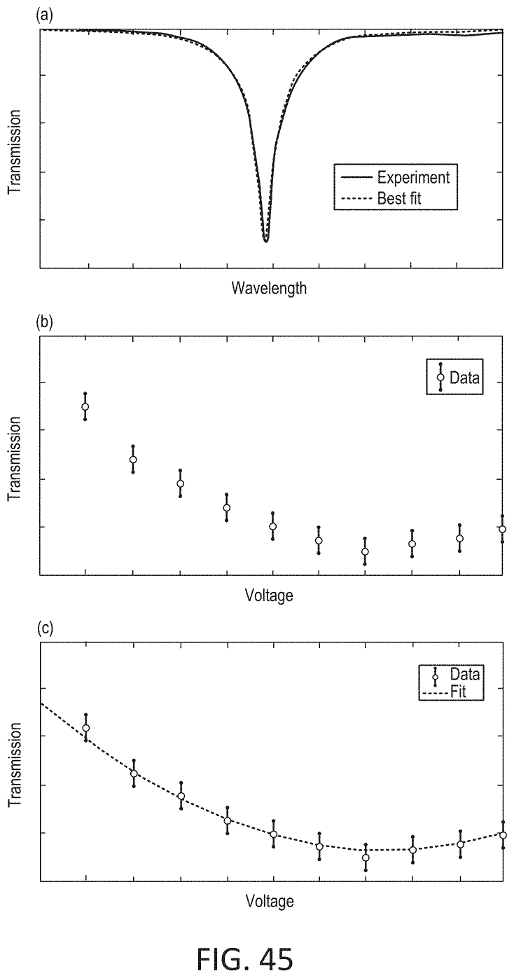

FIG. 45 illustrates transmission parameters as a function of applied voltage in accordance with one or more embodiments of the present technology. In some embodiments, above the top cladding there are electrodes 220 μm in length on each of the two straight arm sections. All measured data is operated in the TM polarization for a 320 nm thick 450 nm wide SRN waveguide. Result (a) shows measurement of the transmission versus wavelength along with the best fit for a single resonance showing the propagation loss of the circulating mode. Result (b) shows shift in resonance wavelength in pico-meters versus applied voltage. Result (c) shows change in effective index versus applied voltage along with the best fit results resulting in a [symbol] ₃₃₃⁽²⁾ of (14.5±1.4) pm/v and a [symbol] ₃₃₃₃⁽³⁾ (6±0.58) m²/V². These measurements are used to determine [symbol] ₃₃₃⁽³⁾ and [symbol] ₃₃₃₃⁽³⁾ by fitting for the change in effective refractive index as a function of applied field using Lumerical mode simulations to solve for the effective refractive index of the guided mode as function of change in spatial dependent material index for the waveguide core. This spatial dependent material index is derived from modeling of the applied field within the waveguide core as a function of applied field using Lumerical Device. In this way a best fit optimization is done to determine [symbol] ₃₃₃⁽²⁾ and [symbol] ₃₃₃₃⁽³⁾ from the measurements, the results of which can be seen in result (c). The propagation loss of the circulating mode can be extracted from result (a) by fitting the measured response to the Lorentzian equation and results in an in-waveguide propagation loss of 3.41 dB/cm for the TM-like polarization. This is done by performing a best fit optimization in order to fit the experimental results to the analytical formula for an all-pass ring resonator. Additionally, the free-spectral range of the racetrack resonator is found to be 0.756 nm which corresponds to a group index of 3.803. The results of the TM-like active optical measurements of resonant wavelength shift versus voltage can be seen in result (b) with result (c) showing the resulting change in effective index versus voltage using equation 6. Result (c) shows the fit for [symbol] ₃₃₃⁽²⁾ and [symbol] ₃₃₃₃⁽³⁾ resulting in values of (14.5±1.4) pm/v and (6±0.58)×10⁻¹⁹ m²/V² respectively. In results (b) and (c), a clear quadratic dependence of the change in resonance wavelength, and change in effective index, on the applied voltage is observed. The minima point is displaced from the origin due to the presence of a non-zero [symbol] ₃₃₃⁽²⁾ in as grown SRN films. The uncertainty in the [symbol] ⁽²⁾ and [symbol] ⁽³⁾ is primarily due the relative wavelength accuracy of the tunable Agilent 8164B CW source used in the measurements. The relative wavelength accuracy of Agilent 8164B CW source is ±3 pm, resulting in an uncertainty in Δn_{eff} of ±1.35×10⁻⁵.

SRN film characteristics are disclosed in this patent document based on the relationship between a SRN film and the [symbol] ⁽³⁾ it will exhibit. Additionally, the [symbol] ⁽³⁾ of the SRN films exceeds that of Silicon. Furthermore, the clear shift in the minimum point in change in refractive index versus voltage confirms the presence of a combination of second and third order nonlinearities as shown in FIG. 45.

This patent document discloses examples of a PECVD based SRN film with a refractive index of 3.02 at 1500 nm, achieving an in-waveguide propagation loss of 3.41 dB/cm for the TM-like polarized optical mode. SRN films, in contrast to highly nonlinear materials such as BaTiO₃, can retain a low RF permittivity of 9.0578 when deposited using PECVD. Additionally, all processing steps are maintained at a temperature of 350° C. or below. PECVD has a major advantage that it is readily compatible with CMOS process flows and maintains a low thermal budget compared to LPCVD, which is typically deposited at temperatures as high as 800° C. and undergo long annealing processes at temperatures as high as 1200° C.

Using the DC-Kerr effect, the [symbol] ₃₃₃₃⁽³⁾ of the SRN film is determined to be (6±0.5 8)×10⁻¹⁹ m²/V² for the TM-like polarized optical mode in the presence of a vertical applied field. The DC-Kerr effect in SRN is used as an optical phase shifter for tuning of a ring-resonator device. This technique can offer an alternative mechanism for employing optical phase shifters in SRN films. Furthermore, PECVD SRN is a highly tunable material which allows a designer to control its refractive index, thermo-optic coefficient, as well as second and third order nonlinear susceptibilities while maintaining low loss and two photon absorption with breakdown field strengths superior to that of silicon. Additionally, when processed using PECVD, a low thermal budget can be maintained using a deposition technique readily available in CMOS process flows. As such, SRN can be used for on chip applications towards highspeed electro-optic switches, analog transmitters, and microwave photonics.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are escribed in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a sub combination or variation of a subcombination.

Only a few implementations and examples are described and other implementations, enhancements and variations can be made based on what is described and illustrated in this patent document.

What is claimed is:

1. An optical device, comprising an optical beam steering and scanning module which steers, controls, or scans a direction of light, wherein the optical beam steering and scanning module comprises:
a substrate;
an array of phase shifting elements supported by the substrate and spaced from one another to receive light incident to one side of the substrate and to interact with the incident light to produce transmitted light on an opposite side of the substrate, each phase shifting element coupled to receive an electrical control signal applied to the phase shifting element and structured to be operable to cause a phase shift on the transmitted light that passes through that phase shifting element in response to the electrical control signal, wherein each phase shifting element is structured to produce the phase shift that varies with the electrical control signal; and
a control circuit coupled to the array of phase shifting elements to apply electrical control signals to the array of phase shifting elements, respectively, one electrical control signal per phase shifting element, the control circuit structured to control the electrical control signals to cause desired phase shifts at the phase shifting elements, respectively, so as to steer and control a direction of the transmitted light,
wherein each phase shifting element comprises:
a semiconductor cylindrical core protruded above the substrate;
a nonlinear optical material formed over the substrate to include a hollow nonlinear optical material cylinder protruded above the substrate to be in contact with and to enclose sidewalls of the semiconductor cylindrical core; and
an external metal layer formed on exterior cylindrical side surface of the hollow nonlinear optical material cylinder,
wherein the control circuit is coupled to the external metal layer and the semiconductor cylindrical core to apply an electrical control signal to control a phase shift in light that passes through each individual phase shifting element.

2. The optical device of claim 1, wherein each phase shifting element further comprises a metal contact line formed over the substrate to include one terminal to be in contact with the external metal layer to supply the electrical control signal.

3. The optical device of claim 2, wherein the nonlinear optical material formed over the substrate comprises a nonlinear optical material layer that covers a surface of the semiconductor substrate that is not covered by the semiconductor cylindrical core and the hollow nonlinear optical material cylinder, wherein the external metal layer formed on exterior cylindrical side surface of the hollow nonlinear optical material cylinder and the metal contact line are located above the nonlinear optical material layer.

4. The optical device of claim 1, wherein the semiconductor substrate and the semiconductor cylindrical core comprise silicon (Si).

5. The optical device of claim 1, wherein the semiconductor substrate and the semiconductor cylindrical core comprise a semiconductor material different from Si.

6. The optical device of claim 1, wherein the nonlinear optical material comprises zirconium oxide (ZrO2).

7. The optical device of claim 1, wherein the nonlinear optical material comprises a material different from ZrO2.

8. The optical device of claim 1, further comprising:
a light detection and ranging (LIDAR) module that comprises the optical beam steering and scanning module to steer and scan light in a LIDAR operation.

9. The optical device of claim 1, wherein the nonlinear optical material comprises a plasma enhanced chemical vapor deposition (PECVD) silicon-rich nitride (SRN) material with a refractive index greater than about 3.

10. A method for steering, controlling, or scanning an optical beam, comprising:
directing an optical beam to transmit through a two-dimensional array of phase shifting elements supported by a substrate, wherein each phase shifting element comprises a semiconductor cylindrical core protruded above the substrate; a nonlinear optical material formed over the substrate to include a hollow nonlinear optical material cylinder protruded above the substrate to be in contact with, and to enclose sidewalls of, the semiconductor cylindrical core, and an external metal layer formed on an exterior cylindrical side surface of the hollow nonlinear optical material cylinder;
applying control voltages to the phase shifting elements, respectively, by applying each control voltage to the hollow nonlinear optical material cylinder via the external metal layer and the semiconductor cylindrical core to cause a phase change in a portion of the optical beam received by a phase shifting element based on a change in a refractive index of the hollow nonlinear optical material cylinder and a surface plasmon condition at an interface of the hollow nonlinear optical material cylinder and the external metal layer; and
controlling the applied control voltages at the different phase shifting elements to cause desired phase shifts at the phase shifting elements, respectively, so as to steer and control the optical beam that transmit through the two-dimensional array of phase shifting elements.

11. The method of claim 10, wherein the substrate and the semiconductor cylindrical core comprise silicon (Si).

12. The method of claim 10, wherein the substrate and the semiconductor cylindrical core comprise a semiconductor material different from Si.

13. The method of claim 10, wherein the nonlinear optical material comprises zirconium oxide (ZrO2).

14. The method of claim 10, wherein the nonlinear optical material comprises a plasma enhanced chemical vapor deposition (PECVD) silicon-rich nitride (SRN) material with a refractive index greater than about 3.

15. A device for modulating light, comprising:
a semiconductor substrate including silicon;
a nonlinear optical material structure formed over the semiconductor substrate to receive and guide light and structured to include a nonlinear optical material that is formed via silicon processing compatible process and includes a silicon-rich nitride (SRN) material; and
one or more electrodes formed near the nonlinear optical material structure to apply an electrical control signal to cause a nonlinear optical effect in the nonlinear optical material structure to modulate the light guided by the nonlinear optical material structure.

16. The device as in claim 15, comprising:
a silicon oxide layer formed over the semiconductor substrate,
wherein the nonlinear optical material structure is embedded in the silicon oxide layer, and the one or more electrodes are formed over the silicon oxide layer.

17. The device as in claim 16, wherein:
the nonlinear optical material structure includes a portion that forms an optical waveguide,
a signal electrode is formed over the silicon oxide layer and located above the optical waveguide as one of the electrodes, and
two ground electrodes formed over the silicon oxide layer and located on two opposite sides of the optical waveguide as part of the electrodes, wherein the two ground electrodes are grounded so that the signal electrode receives and applies the electrical control signal to modulate the light guided by the nonlinear optical material structure.

18. The device as in claim 15, further comprising:
a semiconductor cylindrical core formed over the semiconductor substrate to protrude above the semiconductor substrate,
wherein the nonlinear optical material structure includes a hollow nonlinear optical material cylinder protruded above the substrate to be in contact with and to enclose sidewalls of the semiconductor cylindrical core, and
wherein an external metal layer is formed on an exterior cylindrical side surface of the hollow nonlinear optical material cylinder as part of the one or more electrodes to apply the electrical control signal to the hollow nonlinear optical material cylinder to modulate the light present at the nonlinear optical material structure to cause a phase shift of the light upon transmission through the semiconductor cylindrical core and the hollow nonlinear optical material cylinder.

19. The device as in claim 15, wherein the nonlinear optical material structure includes a ring resonator to guide the light to circulate in the ring resonator, and
wherein the device further includes an optical waveguide formed over the semiconductor substrate and structured to include a waveguide section located adjacent to the ring resonator to be optically coupled to the ring resonator to receive a portion of the light guided by the ring resonator to produce an optical output from the ring resonator.

20. The device as in claim 15, wherein the silicon-rich nitride (SRN) material is structured to have a refractive index that is around or higher than 3.
